(19) United States
(12) Patent Application Publication
(10) Pub. No.: US 2018/0355625 A1
(43) Pub. Date: Dec. 13, 2018

(54) WORK GONDOLA

(71) Applicant: Marutaka-Kogyo Inc., Tokyo (JP)

(72) Inventors: Kazumasa TAKAGI, Tokyo (JP); Eizou TAKAGI, Tokyo (JP); Yasuyuki WATANABE, Tokyo (JP); Nobuyuki CHIBA, Tokyo (JP)

(21) Appl. No.: 15/571,306

(22) PCT Filed: May 6, 2016
(86) PCT No.: PCT/JP2016/063651

§ 371 Date: Nov. 2, 2017

(30) Foreign Application Priority Data
May 8, 2015 (JP) 2015-095648

(51) Int. Cl. E04G 3/32; E04G 5/04

(52) U.S. Cl. CPC E04G 3/325; B66B 9/187; E04G 5/041

(57) ABSTRACT

A work gondola comprises a suction attachment device which is mounted on a front portion of the gondola opposing an outer wall of a building, and which couples and fixes the gondola to the outer wall of the building while being attached to the outer wall of the building by suction. The suction attachment device is formed from a first support column extending in a front-rear direction from the front portion of the gondola, a second support column mounted on the front portion of the gondola and extending in a width direction, and a vacuum gripper attached to a distal-end portion of the first support column. The work gondola which can be fixed onto the outer wall of a building to achieve positional stabilization in the air, and which enables accurate and reliable performance of work involved in various construction operations.

### TECHNICAL FIELD

The present invention relates to a work gondola disposed on an outer side of a structure and capable of elevating in a vertical direction and used in various construction works to the structure.

### BACKGROUND ART

In order to ensure safe scaffold in a high-place work, a work gondola suspended from a rooftop of a structure, capable of elevating in the vertical direction by an elevating device (a hoisting accessory, a hoisting wire rope, a hoisting machine) is used. In the work gondola, a worker gets on it, the worker reaches out his/her hand to a space between the structure and the gondola from a front portion (a front-surface opening) of the gondola (a work cage) and the worker performs various construction works to the structure. The various construction works include very-high building construction work, a general building construction work, a blast painting work, an outer-wall repair work, an outer-wall cleaning work, a sash construction work, a glass construction work, a signboard construction work, a concrete prefabrication work, a bridge construction work, a dam construction work, an expressway construction work and the like.

As an example of the work gondola, a work gondola device used for an aseismic reinforcing work for reinforcing earthquake resistance of a concrete structure by forming a slit in an outer wall surface of the concrete structure is disclosed (see Patent Literature 1). The work gondola device disclosed in Patent Literature 1 includes a base plate and a frame assembled on the base plate, three winches are fixed at substantially equal positions of the base plate or the frame with respect to the center of gravity of the entire gondola device, a crane and a control box are fixed to the base plate or the frame, the crane movably holds a cutter forming a slit for aseismic reinforcement, and a winch control portion for elevating the gondola device by operating the three winches in synchronization and a cutter control portion for controlling the cutter are set in the control box. The cutter controlled by the cutter control portion of this work gondola device is a dry cutter for cutting a wall surface of a building without scattering dusts by covering a cutter edge with a cutter cover connected to a dust collector mounted on the base plate.

### CITATION LIST

### Patent Literature

[Patent Literature 1] Japanese Patent Laid-Open No. 2014-201959

### SUMMARY OF THE INVENTION

### Problems to be Solved by the Invention

The work gondola device disclosed in Patent Literature 1 cannot be fixed onto the wall surface of a construction work spot of a concrete structure, and the gondola swings irregularly and unexpectedly by influences of winds or various works to the wall surface of the concrete structure and thus, an attitude in the air cannot be made stable. Since the work gondola device swings irregularly and unexpectedly during a predetermined construction work, the worker needs to perform the predetermined work involved in the construction work to the wall surface of the concrete structure in a swinging state, and the works involved in the various construction works cannot be performed accurately and reliably. Moreover, depending on a degree of the swing, a safe scaffold cannot be ensured, which involves a risk in the work in some cases, and the work cannot be proceeded with safely. Furthermore, when an accurate work according to a design is to be performed, the worker needs to stop the swinging motion (the swing) of the gondola at each work or another worker needs to perform an operation to maintain the stationary state of the gondola, which takes time and labor in the works involved in the construction work, and the construction work cannot be proceeded with rapidly and efficiently.

An object of the present invention is to provide a work gondola which can be fixed to the outer surface of the structure, whereby an attitude in the air can be stabilized and can perform works involved in various construction works accurately and reliably. Another object of the present invention is to provide a work gondola which can proceed with the work safely and can proceed with the construction work rapidly and efficiently.

### Means for Solving the Problem

A premise of the present invention in order to solve the aforementioned problem is a work gondola disposed on an outer side of a structure, capable of elevating in a vertical direction by using an elevating device and used in various construction works to the structure.

A feature of the present invention in the aforementioned premise is that the work gondola has a suction attachment device installed on a front portion of the gondola faced with the structure and coupling the gondola to the structure while being attached to the outer surface of the structure by suction.

As an example of the present invention, the suction attachment device is formed by a first support column extending in a front-rear direction from the front portion of the gondola and a vacuum gripper mounted on a distal-end portion of the first support column, and the vacuum gripper is formed by a gripper housing having a suction surface with a predetermined area and a sealing foam or a plurality of elastically deformable vacuum pads installed on the suction surface of the gripper housing, having a plurality of suction ports and having a predetermined area and a predetermined thickness with flexibility.

As another example of the present invention, the vacuum gripper is coupled to the distal-end portion of the first support column turnably by a joint.

As another example of the present invention, the suction attachment device includes a second support column installed on the front portion of the work gondola and extending in a width direction, and the first support column is coupled to the second support column turnably and slidably in the width direction by the joint.

As another example of the present invention, the first support column is formed by a turning rod coupled to the second support column turnably and slidably in the width direction by the joint and at least one slide rod slidable in the front-rear direction from the turning rod.

As another example of the present invention, the work gondola includes a cover sheet capable of being extended/contracted and installed at least on a bottom portion or a center portion and both side portions in a top portion and the bottom portion or the center portion and the both side portions thereof, extending in a front-rear direction from the front portion and closing a space between the gondola and the structure, and the cover sheet is capable of adjusting a length dimension in the front-rear direction in accordance with a distance of the space.

As another example of the present invention, the work gondola includes a front frame installed on the front portion, the front frame is formed at least by a lower rod and both side rods in an upper rod located at a top portion of the gondola and extending in the width direction, the lower rod located on the bottom portion or the center portion of the gondola and extending in the width direction, and the both side rods located on the both side portions of the gondola and extending in the vertical direction, and the cover sheet is installed at least on the lower rod and the both side rods in the upper and lower rods and the both side rods.

As another example of the present invention, a contact member having cushioning characteristics and in contact with the outer surface of the structure and having a predetermined area and a predetermined thickness is mounted on a front end portion of the cover sheet faced with the structure.

As another example of the present invention, the work gondola includes a slide rail extending in the front-rear direction from at least upper and lower parts of the both side rods in the both side portions of the upper and lower rods and the upper and lower parts of the both side rods and extending/contracting the cover sheet in the front-rear direction, the slide rail is formed by a fixed rail fixed to the rod and at least one movable rail installed on the cover sheet and slidable in the front-rear direction from the fixed rail, and a coil spring urging the movable rail to a front in the front-rear direction is installed on the slide rail.

As another example of the present invention, the work gondola includes an extension/contraction rod capable of extending/contracting in the front-rear direction and maintaining a contact state of the front end portion of the cover sheet with the structure, and the extension/contraction rod has a base-end portion installed on the gondola and a distal-end portion for pressing the front end portion of the cover sheet and extends in the front-rear direction from at least one of a first corner part where the upper rod crosses the both side rods, a second corner part where the lower rod crosses the both side rods, and center portions in the vertical direction of the both side rods.

As another example of the present invention, the cover sheet is formed by a plurality of bellows frames located on the space and arrayed in the front-rear direction and a bellows sheet mounted on the bellows frames and capable of extension/contraction in the front-rear direction, the bellows sheet has a fixed portion fixed to the front frame and an extension/contraction portion extending to the front in the front-rear direction from the fixed portion and bellow-folded in the front-rear direction between those bellows frames, and the contact member is mounted on the front end portion of the extension/contraction portion of the bellows sheet faced with the structure.

As another example of the present invention, the work gondola includes a front handrail extending in the width direction between the both side rods and a fall-preventing plate installed on the front handrail and closing the space, and the fall-preventing plate is formed by a turning plate turnably installed on the front handrail and at least one slide plate slidable in the front-rear direction from the turning plate, and when the fall-preventing plate is in use, the turning plate and the slide plate are inclined with an ascending gradient from the front handrail toward the structure.

As another example of the present invention, the contact member having the cushioning characteristics and in contact with the outer surface of the structure and having the predetermined area is mounted on the front end portion of the fall-preventing plate faced with the structure.

As another example of the present invention, the work gondola includes a net cover covering a top-surface opening opened on the top portion thereof, both side surface openings opened on the both side portions thereof, and a rear-surface opening opened on a rear portion of the gondola not faced with the structure.

### Advantageous Effect of the Invention

According to the work gondola according to the present invention, since the gondola is coupled to the outer surface of the structure by the suction attachment device attached to the outer surface of the structure, the gondola does not swing but the gondola can be made stationary in the air, whereby the attitude of the gondola in the air can be made stable. In the work gondola, since the worker can perform the predetermined operation in the state where the gondola is made stationary by the suction attachment device, works involved in the various construction works can be performed accurately and reliably. In the work gondola, operations using it do not involve dangers but the operations can be proceeded with safely, and swing of the gondola does not have to be made stationary each time or the worker does not have to perform a manipulation for maintaining the stationary of the gondola, whereby the construction works can be proceeded with rapidly and efficiently.

In the work gondola in which the suction attachment device is formed by the first support column extending in the front-rear direction from the front portion of the gondola and the vacuum gripper mounted on the distal-end portion of the first support column, and the vacuum gripper is formed by the gripper housing having the suction surface with a predetermined area and the sealing foam or the plurality of elastically deformable vacuum pads installed on the suction surface of the gripper housing, having a plurality of suction ports and having a predetermined area and a predetermined thickness with flexibility, the gondola is coupled to the outer surface of the structure by the vacuum gripper attached to the outer surface of the structure and thus, the gondola does not swing but the gondola can be made stationary in the air, whereby the attitude of the gondola in the air can be made stable. In the work gondola, the suction ports of the sealing foam or the plurality of vacuum pads enter the vacuum state, the vacuum gripper exerts a strong suctioning force, and the gondola can be coupled/fixed to the outer surface of the structure reliably by the vacuum gripper. In the work gondola, even if the outer surface of the structure is an irregular surface, the flexible sealing foam with the predetermined area and the predetermined thickness follows the irregularity and its thickness changes, and the plurality of suction ports are attached to the irregular surface and thus, the vacuum gripper is reliably attached to the irregular surface of the structure, and the gondola can be coupled/fixed to the irregular surface of the structure reliably. In the work gondola in which the plurality of elastically deformable vacuum pads are installed on the suction surface of the vacuum gripper, even if the outer surface of the structure is an irregular surface, the plurality of vacuum pads follows the irregularity and is deformed, and the plurality of vacuum pads is attached to the irregular surface and thus, the vacuum gripper is attached to the irregular surface of the structure reliably, and the gondola can be fixed to the irregular surface of the structure reliably.

In the work gondola in which the vacuum gripper is turnably coupled to the distal-end portion of the first support column by the joint, even if the gondola slightly swings by the influence of the winds or the various works to the structure, the swing motion is absorbed by the joint, and the swing motion of the gondola is not transmitted to the vacuum gripper, whereby unexpected separation of the gripper from the outer surface of the structure caused by the transmission of the swing motion to the vacuum gripper can be prevented, the attached state of the vacuum gripper to the outer surface of the structure can be maintained, and the gondola can be coupled/fixed to the outer surface of the structure by the vacuum gripper reliably. In the work gondola, even if the outer surface of the structure is an inclined surface, the suction surface of the vacuum gripper can be made in parallel with the inclined surface of the structure by turning the vacuum gripper by the joint and thus, the entire region of the suction surface of the vacuum gripper can be attached to the inclined surface of the structure, whereby the gondola can be coupled/fixed to the inclined surface of the structure by the vacuum gripper reliably.

In the work gondola including the second support column installed on the front portion of the gondola and extending in the width direction and the first support column coupled to the second support column by the joint turnably and slidably in the width direction, even if the gondola slightly swings by the influence of the winds or various works to the outer surface of the structure, the swing motion is absorbed by the joint, and the swing motion of the gondola is not transmitted to the first support column or the vacuum gripper, whereby unexpected separation of the gripper from the outer surface of the structure caused by the transmission of the swing motion from the first support column to the vacuum gripper can be prevented, the attached state of the vacuum gripper to the outer surface of the structure can be maintained, and the gondola can be coupled/fixed to the outer surface of the structure by the vacuum gripper reliably. In the work gondola, since the first support column is coupled to the second support column slidably in the width direction, the vacuum gripper can be attached to an optimal spot on the outer surface of the structure while the vacuum gripper is moved to the width direction of the second support column together with the first support column, and the gondola can be coupled/fixed to the outer surface of the structure by the vacuum gripper reliably. In the work gondola, even if the outer surface of the structure is an inclined surface, the suction surface of the vacuum gripper can be made in parallel with the inclined surface of the structure by turning the first support column by the joint and thus, the entire region of the suction surface of the vacuum gripper can be attached to the inclined surface of the structure, and the gondola can be coupled/fixed to the inclined surface of the structure by the vacuum gripper reliably.

In the work gondola formed by the turning rod in which the first support column is coupled to the second support column turnably and slidably in the width direction by the joint and at least one slide rod slidably from the turning rod to the front-rear direction, even if the gondola slightly swings by the influence of the winds or various works to the outer surface of the structure, the swing motion is absorbed by the joint, and the swing motion of the gondola is not transmitted to the turning rod, the slide rod or the vacuum gripper, whereby unexpected separation of the gripper from the outer surface of the structure caused by the transmission of the swing motion from those rods to the vacuum gripper can be prevented, the attached state of the vacuum gripper to the outer surface of the structure can be maintained, and the gondola can be coupled/fixed to the outer surface of the structure by the vacuum gripper reliably. In the work gondola, since the turning rod is coupled to the second support column slidably to the width direction, the vacuum gripper can be attached to an optimal spot on the outer surface of the structure while the vacuum gripper is moved to the width direction of the second support column together with the turning rod, and the gondola can be coupled/fixed to the outer surface of the structure by the vacuum gripper reliably. In the work gondola, even if the outer surface of the structure is an inclined surface, the suction surface of the vacuum gripper can be made in parallel with the inclined surface of the structure by turning the turning rod by the joint and thus, the entire region of the suction surface of the vacuum gripper can be attached to the inclined surface of the structure, and the gondola can be coupled/fixed to the inclined surface of the structure by the vacuum gripper reliably. In the work gondola, the slide rod is slidable from the turning rod in the front-rear direction, and by sliding the turning rod in the front-rear direction, the length dimensions of those rods can be made longer or shorter.

In the work gondola including the cover sheet capable of being extended/contracted, installed at least on the bottom portion or the center portion and the both side portions in the top portion and the bottom portion or the center portion and the both side portions of the gondola, extending in the front-rear direction from the front portion and closing a space between the gondola and the structure, and the cover sheet being capable of adjusting the length dimension in the front-rear direction in accordance with a distance of the space, solid wastes such as concrete debris, mortar debris, tile debris and the like are generated during the various construction works to the structure in some cases, but since the space between at least the bottom portion or the center portion and the both side portions of the gondola and the structure can be closed by the cover sheet, those solid wastes generated during the construction works can be captured by the cover sheet, and scattering of the wastes from the gondola to all directions or a fall of the wastes from the gondola can be prevented by the cover sheet. In the work gondola, since the scattering of the wastes generated during the various construction works from the gondola to all directions or the fall of the wastes from the gondola can be prevented by the cover sheet, safety around the structure during the construction work can be ensured, and there is no need to provide various safety measures such as installation of a protective net or a partition plate and the like or deployment of a watchman around the structure, whereby a cost or a labor required for the safety measures can be saved, and the various construction works to the structure can be performed rapidly and inexpensively. In the work gondola, since the length dimension of the cover sheet in the front-rear direction can be adjusted in accordance with the distance of the space, the length dimension of the cover sheet in the front-rear direction can be matched with the distance of the space, and the space can be reliably closed by the cover sheet and the scattering of the wastes from the gondola to all directions or the fall of the wastes from the gondola can be prevented reliably.

In the work gondola including the front frame installed on the front portion of the gondola, the front frame being formed at least by the lower rod and the both side rods in the upper rod located at the top portion of the gondola, the lower rod located on the bottom portion or the center portion of the gondola, and the both side rods located on the both side portions of the gondola, and the cover sheet being installed at least on the lower rod and the both side rods in the upper and lower rods and the both side rods, the space between at least the bottom portion or the center portion and the both side portions of the gondola and the structure can be closed by the cover sheet extending at least from the lower rod and the both side rods in the upper and lower rods and the both side rods and thus, the solid wastes such as concrete debris, mortar debris, tile debris and the like generated during the various construction works to the structure can be captured by the cover sheet, and the scattering of the wastes from the gondola to all directions or the fall of the wastes from the gondola can be prevented reliably by the cover sheet.

In the work gondola in which the contact member having the cushioning characteristics and in contact with the outer surface of the structure and having the predetermined area and the predetermined thickness is mounted on the front end portion of the cover sheet faced with the structure, since the contact member having the cushioning characteristics and having the predetermined area and the predetermined thickness mounted on the front end portion of the cover sheet is brought into close contact with the outer surface of the structure, a gap is not generated between the structure and the front end portion of the cover sheet, the space between the gondola and the structure can be closed by the cover sheet without a gap, and the scattering of the solid wastes such as concrete debris, mortar debris, tile debris and the like from the gondola to all directions or the fall of the wastes from the gondola can be prevented reliably.

In the work gondola including the slide rail extending in the front-rear direction from at least the upper and lower parts of the both side rods in the both side portions of the upper and lower rods and the upper and lower parts of the both side rods and extending/contracting the cover sheet in the front-rear direction, the slide rail being formed by the fixed rail fixed to the rod and at least one movable rail installed on the cover sheet and slidable in the front-rear direction from the fixed rail, and the coil spring urging the movable rail to the front in the front-rear direction being installed on the slide rail, by sliding the movable rail extending from at least the upper and lower parts of the both side rods in the both side portions of the upper and lower rods and the upper and lower parts of the both side rods to the front in the front-rear direction, the cover sheet is extended to the front in the front-rear direction, and by sliding the movable rail to the rear in the front-rear direction, the cover sheet is contracted to the rear in the front-rear direction and thus, the cover sheet can be extended to the front in the front-rear direction easily and can be contacted to the rear in the front-rear direction easily, and the space between the gondola and the structure can be closed reliably by using the slide rail and the cover sheet. In the work gondola, since the length dimension of the cover sheet in the front-rear direction can be adjusted by using the slide rail, the length dimension of the cover sheet in the front-rear direction can be matched with the distance of the space easily, and the space can be closed by the cover sheet reliably and moreover, the scattering of the solid wastes such as the concrete debris, mortar debris, tile debris and the like from the gondola to all directions or the fall of the wastes from the gondola can be prevented reliably. In the work gondola, the movable rail is urged by the coil spring to the front in the front-rear direction, whereby the cover sheet is pressed to the front in the front-rear direction and is brought into close contact with the outer surface of the structure and thus, no gap is generated between the structure and the front end portion of the cover sheet, and the space between the gondola and the structure can be closed by the cover sheet without a gap.

In the work gondola including the extension/contraction rod capable of extending/contracting in the front-rear direction and maintaining the contact state of the front end portion of the cover sheet with the structure, the extension/contraction rod having the base-end portion installed on the gondola and the distal-end portion for pressing the front end portion of the cover sheet, and the extension/contraction rod extending in the front-rear direction from at least one of the first corner part where the upper rod crosses the both side rods, the second corner part where the lower rod crosses the both side rods, and the center portions in the vertical direction of the both side rods, since the distal-end portion of the extension/contraction rod extending from at least one of those portions presses the front end portion of the cover sheet, the close contact state of the front end portion of the cover sheet with the outer surface of the structure is maintained, and since the front end portion of the cover sheet is brought into close contact with the structure by the extension/contraction rod, there is no gap generated between the structure and the front end portion of the cover sheet, and the space between the gondola and the structure can be closed by the cover sheet without a gap, the scattering of the solid wastes such as concrete debris, mortar debris, tile debris and the like from the gondola to all directions or the fall of the wastes from the gondola can be prevented reliably.

In the work gondola in which the cover sheet is formed by the plurality of bellows frames arrayed in the front-rear direction and the bellows sheet mounted on the bellows frames and capable of extension/contraction in the front-rear direction, the bellows sheet having the fixed portion fixed to the front frame and the extension/contraction portion extending to the front in the front-rear direction from the fixed portion and bellow-folded in the front-rear direction between those bellows frames, and the contact member being mounted on the front end portion of the extension/contraction portion of the bellows sheet faced with the structure, since the extension/contraction portion of the bellow-folded bellows sheet is extended/contracted in the space in the front-rear direction, and the extension/contraction portion of the bellows sheet can close the space between at least the bottom portion and the both side portions of the gondola and the structure, the solid wastes such as concrete debris, the mortar debris, the tile debris and the like generated during the various construction works to the structure can be captured by the bellows sheet, and the scattering of the wastes from the gondola to all directions or the fall of the wastes from the gondola can be prevented by the bellows sheet. In the work gondola, scattering of the wastes generated in the various construction works from the gondola to all directions or a fall of the wastes from the gondola can be prevented by the bellows sheet and thus, safety around the structure during the construction work can be ensured, and there is no need to provide various safety measures such as installation of a protective net or a partition plate and the like or deployment of a watchman around the structure, whereby a cost or a labor required for the safety measures can be saved, and the various construction works to the structure can be performed rapidly and inexpensively. In the work gondola, since the length dimension of the extension/contraction portion of the bellows sheet in the front-rear direction can be adjusted in accordance with the distance of the space, the length dimension of the extension/contraction portion of the bellows sheet in the front-rear direction can be matched with the distance of the space, and the space can be closed by the extension/contraction portion of the bellows sheet without a gap and the scattering of the wastes from the gondola to all directions or the fall of the wastes from the gondola can be prevented reliably.

In the work gondola including the front handrail extending in the width direction between the both side rods and the fall-preventing plate installed on the front handrail and closing the space, the fall-preventing plate being formed by the turning plate turnably installed on the front handrail and at least one slide plate slidable in the front-rear direction from the turning plate, and when the fall-preventing plate is in use, the turning plate and the slide plate are inclined with an ascending gradient from the front handrail toward the structure, by sliding the slide plate with respect to the turning plate in the front-rear direction, the fall-preventing plate can be extended to the front in the front-rear direction easily and can be contracted to the rear in the front-rear direction easily, whereby the space between the front handrail of the gondola and the structure can be closed without a gap by using the turning plate and the slide plate, and the solid wastes such as concrete debris, mortar debris, tile debris and the like can be accommodated in the gondola from the fall-preventing plate by using the fall-preventing plate reliably. In the work gondola, since the turning plate and the slide plate are inclined with an ascending gradient from the front handrail toward the structure when the fall-preventing plate is in use, the solid wastes such as concrete debris, mortar debris, tile debris and the like generated during the various construction works to the structure fall from the fall-preventing plate on the structure side toward the side of the front handrail and thus, the wastes can be accommodated in the gondola from the fall-preventing plate reliably. In the work gondola, since the scattering of the wastes from the gondola to all directions or the fall of the wastes from the gondola can be prevented by the fall-preventing plate, safety around the structure during the construction work can be ensured, and there is no need to provide various safety measures such as installation of a protective net or a partition plate and the like or deployment of a watchman around the structure, whereby a cost or a labor required for the safety measures can be saved, and the various construction works to the structure can be performed rapidly and inexpensively. In the work gondola, since the length dimension of the fall-preventing plate in the front-rear direction can be adjusted in accordance with the distance of the space, the length dimension of the fall-preventing plate in the front-rear direction can be matched with the distance of the space, a gap is not generated between the front handrail and the structure, and the wastes can be accommodated in the gondola reliably by using the fall-preventing plate.

In the work gondola in which the contact member having the cushioning characteristics and in contact with the outer surface of the structure and having the predetermined area is mounted on the front end portion of the fall-preventing plate faced with the structure, since the contact member having the cushioning characteristics and having the predetermined area and mounted on the front end portion of the fall-preventing plate is brought into close contact with the structure, a gap is not generated between the structure and the front end portion of the fall-preventing plate, the space between the gondola and the structure can be closed by the fall-preventing plate without a gap, and the solid wastes such as concrete debris, mortar debris, tile debris and the like generated during the various construction works to the structure can be accommodated in the gondola from the fall-preventing plate reliably, and the scattering of the wastes from the gondola to all directions or the fall of the wastes from the gondola can be prevented reliably.

In the work gondola including the net cover covering the top-surface opening opened on the top portion thereof, the both side surface openings opened on the both side portions thereof, and the rear-surface opening opened on the rear portion, since the top-surface opening, the both side surface openings, and the rear-surface opening of the gondola are covered by the net cover, the solid wastes such as concrete debris, mortar debris, tile debris and the like generated during the various construction works to the structure do not scatter from the top-surface opening, the both side surface openings, the rear-surface opening of a work cage, whereby the scattering of the wastes from the gondola to all directions or the fall of the wastes from the gondola can be prevented by the net cover, and safety around the structure during the construction work can be ensured sufficiently.

### BRIEF DESCRIPTION OF THE DRAWINGS

FIG. 1 is a perspective view illustrating an example of a work gondola.

FIG. 2 is a front view of the work gondola.

FIG. 3 is a rear view of the work gondola.

FIG. 4 is a side view of first and second support columns and a vacuum gripper illustrated as an example.

FIG. 5 is a front view of the first and second support column and the vacuum gripper in FIG. 4.

FIG. 6 is a side view of the first and second support columns and the vacuum gripper illustrated as another example.

FIG. 7 is a front view of the first and second support columns and the vacuum gripper in FIG. 6.

FIG. 8 is a side view of the work gondola before it is coupled to an outer wall of a building.

FIG. 9 is a side view of the work gondola after it is coupled to the outer wall of the building.

FIG. 10 is a perspective view of the work gondola illustrated as another example.

FIG. 11 is a front view of the work gondola.

FIG. 12 is a rear view of the work gondola.

FIG. 13 is a partially enlarged side view of a cover sheet, a slide rail, and an extension/contraction rod before extension.

FIG. 14 is a partially enlarged side view of the cover sheet, the slide rail, and the extension/contraction rod before extension.

FIG. 15 is a partially enlarged perspective view of a fall-preventing plate after extension.

FIG. 16 is a partially enlarged perspective view of the fall-preventing plate after extension.

FIG. 17 is a side view of the work gondola before being coupled to the outer wall of the building.

FIG. 18 is a side view of the work gondola after being coupled to the outer wall of the building.

FIG. 19 is a perspective view of the work gondola illustrated as another example.

FIG. 20 is a front view of the work gondola.

FIG. 21 is a rear view of the work gondola.

FIG. 22 is a side view of the work gondola after being coupled to the outer wall of the building.

### DESCRIPTION OF EMBODIMENT

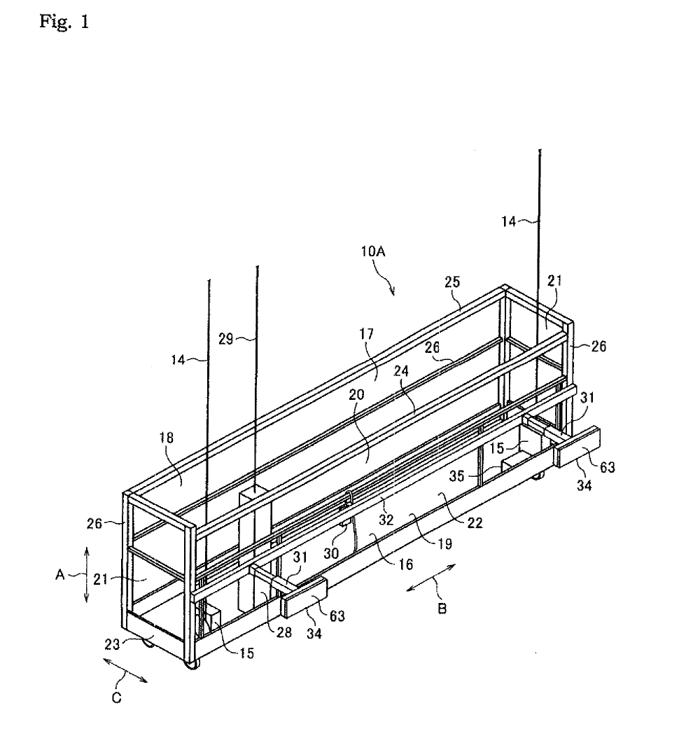

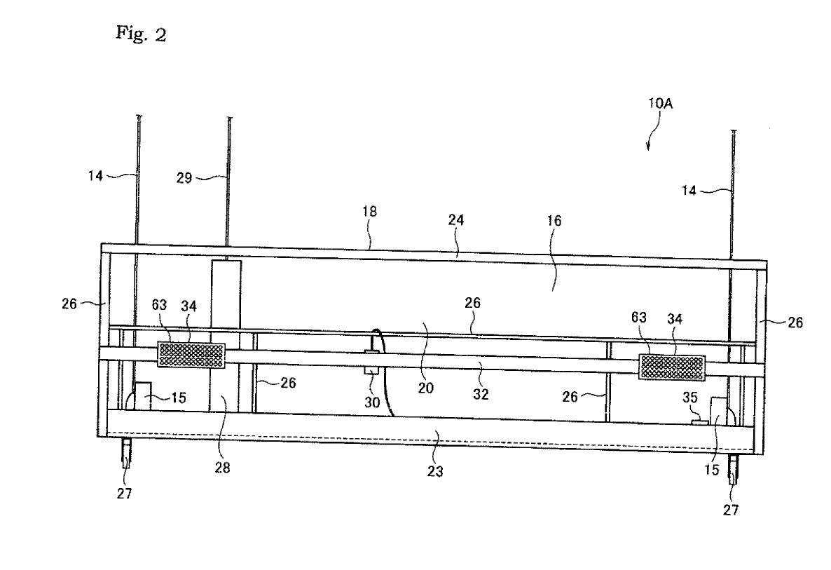

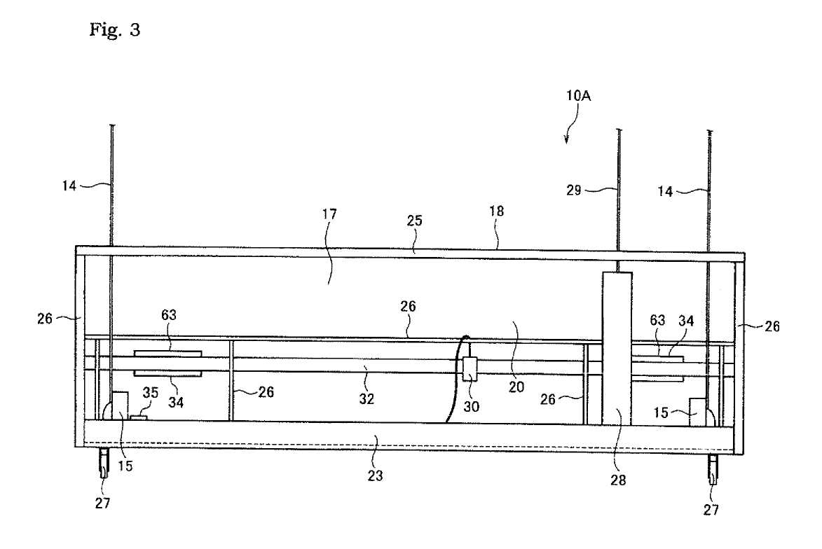

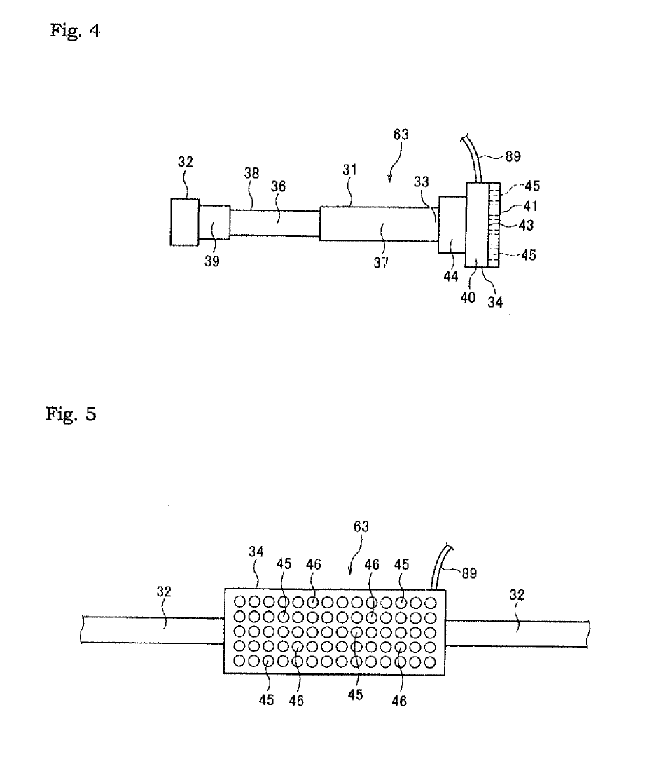

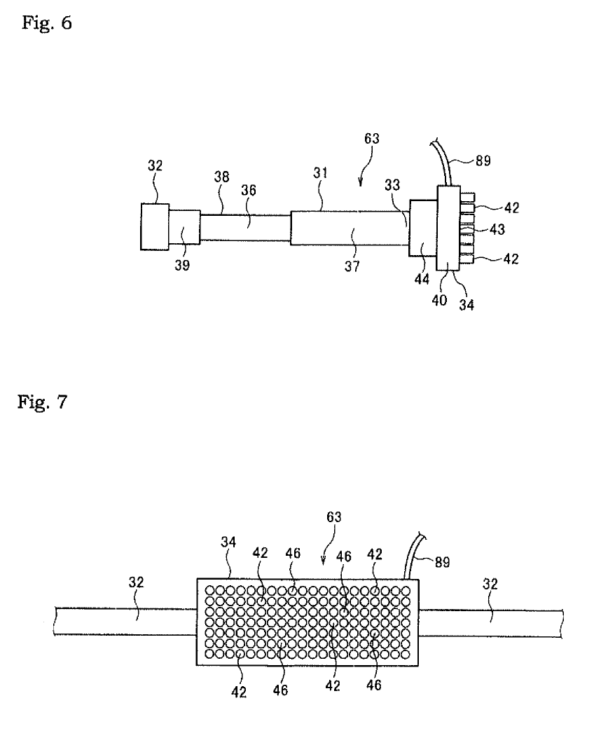

By referring to the attached drawings such as FIG. 1 which is a perspective view illustrating an example of a work gondola 10A, details of the work gondola according to the present invention will be described as follows. It is to be noted that FIG. 2 is a front view of the work gondola 10A, and FIG. 3 is a rear view of the work gondola 10A. FIG. 4 is a side view of first and second support columns and a vacuum gripper illustrated as an example, and FIG. 5 is a front view of the first and second support columns and the vacuum gripper in FIG. 4. FIG. 6 is a side view of the first and second support columns and the vacuum gripper illustrated as another example, and FIG. 7 is a front view of the first and second support columns and the vacuum gripper in FIG. 6.

In FIG. 1, illustration of a net cover is partially omitted. In FIGS. 1 to 3, illustration of a vacuum hose 89 is omitted. In FIGS. 4 and 5, a sealing foam is attached to a suction surface of the vacuum gripper, and in FIGS. 6 and 7, a plurality of vacuum pads are attached to the suction surface of the vacuum gripper. In FIG. 1, a vertical direction is indicated by an arrow A, a width direction is indicated by an arrow B, and a front-rear direction is indicated by an arrow C. In FIGS. 4 and 6, a front in the front-rear direction is indicated by an arrow C1, and a rear in the front-rear direction is indicated by an arrow C2. In the work gondola 10A (including gondolas 10B and 10C), a building 11 is described as an example of a structure. It is to be noted that the structure includes a bridge, a dam, an expressway and the like in addition to the building 11.

The work gondola 10A is used for ensuring a safe scaffold in a high-place work when various construction works are performed to the building 11 (the structure). The work gondola 10A is disposed on an outer side of an outer wall 12 of the building 11 and is suspended from a rooftop of the building 11, capable of elevating in the vertical direction by an elevating device. In the work gondola 10A, a worker gets on it, the worker reaches out his/her hand to a space 13 between the outer wall 12 of the building 11 and the gondola 10A from a front portion (a front-surface opening) of the gondola 10A and the worker performs various construction works to the building 11. The various construction works to the structure include very-high building construction work, a general building construction work, a blast painting work, an outer-wall repair work, a cleaning work, a sash construction work, a glass construction work, a signboard construction work, a concrete prefabrication work, a bridge construction work, a dam construction work, an expressway construction work and the like.

An example of the elevating device is formed by a hoisting accessory (not shown) detachably installed on the rooftop of the building, two hoisting wire ropes 14 extending from the hoisting accessory to the ground, and two endless winder-type hoisting machines 15 for hoisting those hoisting wire ropes 14. For the hoisting accessory, any presently known type of hoisting accessories such as an adjustable hook, a U-shaped hook, an inclined projecting beam type, a balance arm type, a rail/cart type and the like can be used. For the hoisting machine 15, a drum type which hoists the hoisting wire rope by using a drum installed on the rooftop of the building 11 can be also used.

The work gondola 10A has an appearance shape of a substantial rectangle longer in the width direction and has a front portion 16 faced with the outer wall 12 of the building 11, a rear portion 17 located on a side opposite to the front portion 16 and not faced with the outer wall 12 of the building 11, a top portion 18 located on the rooftop side of the building 11, a bottom portion 19 located on the ground side, a center portion 20 located between the top portion 18 and the bottom portion 19, and both side portions 21. The gondola 10A is made by a floor material 22 installed on the bottom portion 19 and having a predetermined area longer in the width direction, a bottom frame 23 (a floor material support plate) supporting the floor material 22, a front handrail 24 (a front handrail) (a square columnar pipe) and a rear handrail 25 (a rear handrail) (a square columnar pipe) located above (the center portion 20 of the gondola 10A) the floor material 22 and extending in the width direction, and a plurality of reinforcing columns 26 (square columnar pipes) coupled to the bottom frame 23, the front handrail 24, and the rear handrail 25 and extending in the vertical direction, the width direction, and the front-rear direction.

The floor material 22 is made of a wooden plate or a metal plate such as a steel material, iron, aluminum, brass, alloy and the like or a composite material in which an outer peripheral surface of a wooden material is covered with metal. The floor material 22 is placed and fixed to the bottom frame 23. The bottom frame 23, the front handrail 24, the rear handrail 25, and the reinforcing column 26 are made of metal such as a steel material, iron, aluminum, brass, alloy and the like. The bottom frame 23, the front handrail 24, the rear handrail 25, and the reinforcing column 26 are coupled by welding. In the gondola 10A, a work space surrounded by the floor material 22, the bottom frame 23, the front handrail 24, the rear handrail 25, and the reinforcing column 26 is defined. It is to be noted that the shape of the work gondola 10A is not limited to the illustration, but a gondola having any shape can be used.

Below each corner part of the bottom frame 23, a caster 27 is mounted. On the floor material 22 on the both side portions 21 of the gondola 10A, a hoisting machine 15 to which the hoisting wire rope 14 is connected is installed/fixed, and on the floor material 22 on one of the side portions 21 of the gondola 10A, a control panel 28 for gondola is placed/fixed. To the control panel 28 for gondola, a power cable 29 suspended from the rooftop of the building 11 is connected, and electricity is supplied to each of the hoisting machines 15 from the control panel 28 by the power cable (not shown). On the reinforcing column 26, a pendant switch 30 connected to the control panel 28 for gondola through the cable is hooked. On the front portion 16, a suction attachment device 63 (suction attachment means) for coupling (fixing) the gondola 10A to the building 11 (making the gondola 10A stationary in the air) while being attached to the outer wall 12 of the building 11 is installed.

The suction attachment device 63 is formed by two first support columns 31 (square columnar pipes) extending to the front-rear direction from the front portion 16 of the gondola 10A, one second support column 32 (a square columnar pipe) installed on the front portion 16 of the gondola 10A and extending in the width direction, two units of vacuum grippers 34 mounted on distal-end portions 33 of the first support columns 32, and a vacuum pump 35 connected to those vacuum grippers 34. It is to be noted that the number of units of the vacuum grippers 34 is not limited, and one unit of the vacuum gripper 34 or three or more units of the vacuum grippers 34 are installed on the gondola 10A depending on a size of the gondola 10A (the width dimension or the vertical dimension) in some cases.

The first and second support columns 31 and 32 are made of metal such as a steel material, iron, aluminum, brass, alloy and the like. The first support column 31 is formed by a turning rod 36 and a slide rod 37 slidable in the front-rear direction from the turning rod 36. The second support column 32 is detachably coupled to the reinforcing column 26 extending between the floor material 21 and the front handrail 24 by a coupling fixture (not shown). In those first support columns 31, a base-end portion 38 of the turning rod 36 is detachably installed on the second support column 32 by a joint 39 (a universal joint, a ball socket joint or the like) and is coupled turnably in the vertical direction and in the width direction with respect to the second support column 32 and slidably in the width direction.

The first support column 31 can determine an installation position in the width direction with respect to the second support column 32 by sliding (moving) the turning rod 36 in the width direction and then, by fixing the base-end portion 38 of the turning rod 36 to the second support column 32 by the joint 39. The turning rod 36 of the first support column 31 turns in the vertical direction and in the width direction with respect to the second support column 32 by the joint 39 even after being fixed to the second support column 32. The first support column 31 includes a slide stopper (a slide fixing mechanism) (not shown) which disables slide (extension/contraction) of the slide rod 37 by fixing the slide rod 37 at a predetermined position of the turning rod 36.

In the first support column 31, by sliding the slide rod 37 to the front in the front-rear direction, the first support column 31 can be extended to the front in the front-rear direction, and the length dimension of the first support column 31 in the front-rear direction can be made longer. On the contrary, by sliding the slide rod 37 to the rear in the front-rear direction, the first support column 31 can be contracted to the rear in the front-rear direction, and the length dimension of the first support column 31 in the front-rear direction can be made shorter.

After the slide rod 37 is slid to the front in the front-rear direction, by fixing the slide rod 37 to the turning rod 36 by the slide stopper (the slide fixing mechanism), a state where the first support column 31 is extended to the front in the front-rear direction can be maintained, and after the slide rod 37 is slid to the rear in the front-rear direction, by fixing the slide rod 37 to the turning rod 36 by the slide stopper (the slide fixing mechanism), a state where the first support column 31 is contracted to the rear in the front-rear direction can be maintained. By extending/contracting the first support column 31 to the front-rear direction by using the slide rod 37, the length dimension of the first support column 31 can be adjusted in accordance with the distance of a space 13.

The vacuum gripper 34 is formed by a gripper housing 40 having a square columnar shape made of aluminum and a sealing foam 41 (a sealing sponge) or a plurality of elastically deformable vacuum pads 42 (suction pads) having flexibility and a predetermined area and a predetermined thickness. The gripper housing 40 has a square suction surface 43 having a predetermined area. In the vacuum gripper 34, a rear surface (a rear portion) of the gripper housing 40 is coupled to a distal-end portion (a distal-end portion 33) of the slide rod 37 (the first support column 31) by a joint 44 (a universal joint, a ball socket joint or the like) turnably in the vertical direction and in the width direction.

It is to be noted that it may be so configured that the turning rod 36 of the first support column 31 is coupled to the second support column 32 turnably in the vertical direction and in the width direction, and the rear surface (the rear portion) of the gripper housing 40 of the vacuum gripper 34 is unturnably fixed to the distal-end portion (the distal-end portion 33) of the slide rod 37 (the first support column 31). Alternatively, the turning rod 36 of the first support column 31 may be fixed to the second support column 32 unturnably in the vertical direction or in the width direction, and the rear surface (the rear portion) of the gripper housing 40 of the vacuum gripper 34 may be coupled to the distal-end portion (the distal-end portion 33) of the slide rod 37 (the first support column 31) turnably in the vertical direction and in the width direction.

As the vacuum gripper 34, a connection type in which a vacuum generating device is not built in the gripper housing 40 and connection is made to the vacuum generating device (the vacuum pump 35 or a vacuum blower) or a built-in type in which the vacuum generating device is built in the gripper housing 40 can be considered. In the gondola 10A in FIG. 1, the connection-type vacuum gripper 34 is in use, and the vacuum pump 35 is placed on/fixed to the floor material 21. In the connection-type vacuum gripper 34, a vacuum-generating device connection port (not shown) of the gripper housing 40 and the vacuum pump 35 (or a vacuum blower) are connected by a vacuum hose 89. To the vacuum pump 35, electricity is supplied from the control panel 28 through the power cable (not shown). ON/OFF of the vacuum gripper 34 (the vacuum pump 35) is switched by the pendant switch 30.

It is to be noted that, in the gondola 10A, the built-in type vacuum gripper 34 can be also used. The built-in type vacuum gripper 34 can be used by supplying a compressed air. When the built-in type vacuum gripper 34 is to be used, a compressed air generating device (an air compressor) is placed on/fixed to the floor material 22, and the gripper housing 40 and the compressed air generating device (the air compressor) are connected by an air hose (not shown). To the compressed air generating device (the air compressor), electricity is supplied from the control panel 28 by the power cable (not shown). ON/OFF of the built-in type vacuum gripper 34 (the compressed air generating device) is switched by the pendant switch 30.

The sealing foam 41 is molded into a square substantially in the same shape as that of the suction surface 43 of the gripper housing 40, has a plurality of suction holes 45 and is detachably attached on the suction surface 43 of the gripper housing 40. When the sealing foam 41 is attached to the suction surface 43 of the gripper housing 40, as illustrated in FIG. 5, a plurality of suction ports 46 present on the suction surface 43 and corresponding to the suction holes 45 of the sealing foam 41 is formed in the vacuum gripper 34. In the vacuum gripper 34 in which the sealing foam 41 is attached to the suction surface 43 of the gripper housing 40, by operating the vacuum pump 35 (by supplying a compressed air to the compressed air generating device in the case of the built-in type), the suction ports 46 are brought into a vacuum state by the pump 35 (or the compressed air generating device), and by bringing the sealing foam 41 (the suction surface 43) into contact with the outer wall 12 of the building 11, the suction ports 43 of the vacuum gripper 34 are attached to the outer wall 12, and the vacuum gripper 34 is attached to the outer surface of the outer wall 12.

If not only a flat surface but a recessed surface or a projecting surface is present on the outer wall 12, the suction port 43 located on the flat surface of the outer wall 12 in those suction ports 43 is attached to the flat surface, while on the recessed surface or the projecting surface of the outer wall 12, the sealing foam 41 is extended/contracted (deformed) and follows the shapes of the recessed surface and the projecting surface of the outer wall 12, and the suction port 43 located on the recessed surface or the projecting surface is attached to the recessed surface or the projecting surface. Therefore, in the vacuum gripper 34 to which the sealing foam 41 is attached, even if there is a recessed surface or a projecting surface on the outer wall 12, the gripper 34 is firmly attached to the outer surface of the outer wall 12. Since the vacuum gripper 34 is attached to the outer surface of the outer wall 12, the work gondola 10A is coupled/fixed to the outer wall 11 of the building 12 through the suction attachment device 63.

In the vacuum gripper 34 to which the sealing foam 41 is attached, when the turning rod 36 of the first support column 31 is capable of turning in the vertical direction and in the width direction with respect to the second support column 32 by the joint 39, and the gripper housing 40 is capable of turning in the vertical direction and in the width direction with respect to the distal-end portion 34 of the slide rod 37 (the first support column 31) by the joint 44 (including a case where the turning rod 36 of the first support column 31 is coupled to the second support column 32 turnably in the vertical direction and in the width direction, and the gripper housing 40 is fixed to the distal-end portion (the distal-end portion 33) of the slide rod 37 (the first support column 31) unturnably or where the turning rod 36 of the first support column 31 is fixed to the second support column 32 unturnably in the vertical direction or in the width direction, and the rear surface (the rear portion) of the gripper housing 40 of the vacuum gripper 34 is coupled to the distal-end portion (the distal-end portion 33) of the slide rod 37 (the first support column 31) turnably in the vertical direction and in the width direction.), even if the work gondola l0A suspended in the air makes a swing motion (swings) due to an influence of winds or works, the swing is absorbed by the joint 39 and the joint 44 and thus, the swing does not directly act on the vacuum gripper 34, and unexpected separation of the suction surface 43 (the suction hole 45 of the sealing foam 41) of the gripper 34 from the outer wall 12 of the building 11 due to the action of the swing on the gripper 34 can be prevented.

In the vacuum gripper 34 to which the sealing foam 41 is attached, after the gripper 34 is attached to the outer wall 12, the turning rod 36 of the first support column 31 is unturnably fixed to the second support column by a fixing fixture (not shown) so as to have the turning rod 36 as an unturnable fixed rod, and the gripper housing 40 is unturnably fixed to the distal-end portion (the distal-end portion 33) of the slide rod 37 (the first support column 31) by a fixing fixture (not shown) in some cases. In this case, by increasing an attaching force (a suctioning force) of the vacuum gripper 34 so as to have the suction surface 43 (the suction hole 45 of the sealing foam 41) of the gripper 34 strongly attached to the outer wall 12 of the building 11, since the work gondola 10A is coupled to the outer wall 12 by the suction attachment device 63, unable to swing, even if there is an influence of winds or works, the gondola l0A does not swing or move but the stationary state of the gondola 10A in the air is held.

Those vacuum pads 42 are made of a rubber material and are extended/contracted (elastically deformed) to front and rear and to right and left with respect to the suction surface 43 of the gripper housing 40. The vacuum pads 42 are detachably attached to the suction surface 43 of the gripper housing 40. When the plurality of vacuum pads 42 are installed on the suction surface 43 of the gripper housing 40, as illustrated in FIG. 7, the plurality of suction ports 46 present on the suction surface 43 is formed by those vacuum pads 43 in the vacuum gripper 34. In the vacuum gripper 34 to which the plurality of vacuum pads 42 is attached to the suction surface 43 of the gripper housing 40, by operating the vacuum pump 35 (by supplying a compressed air to the compressed air generating device in the built-in type), those vacuum pads 42 are brought into the vacuum state by the pump 35 (or the compressed air generating device), and by bringing the vacuum pads 42 (the suction surface 43) into contact with the outer wall 12 of the building 11, those vacuum pads 42 (the suction ports 46) are attached to the outer wall 12, and the vacuum gripper 34 is attached to the outer surface of the outer wall 12.

If not only a flat surface but a recessed surface or a projecting surface is present on the outer wall 12, the vacuum pad 42 located on the flat surface of the outer wall 12 in those vacuum pads 42 is attached to the flat surface, while on the recessed surface or the projecting surface of the outer wall 12, those vacuum pads 42 are extended/contracted (elastically deformed) to front and rear and to right and left and follow the shapes of the recessed surface and the projecting surface of the outer wall 12, and the vacuum pads 42 located on the recessed surface or the projecting surface are attached to the recessed surface or the projecting surface. Therefore, in the vacuum gripper 34 to which the plurality of vacuum pads 42 is attached, even if there is a recessed surface or a projecting surface on the outer wall 12, the gripper 34 is firmly attached to the outer surface of the outer wall 12. Since the vacuum gripper 34 (the plurality of vacuum pads 42) is attached to the outer surface of the outer wall 12, the work gondola 10A is coupled/fixed to the outer wall 12 of the building 11 through the suction attachment device 63.

In the vacuum gripper 34 to which the vacuum pads 42 are attached, the turning rod 36 of the first support column 31 is capable of turning in the vertical direction and in the width direction with respect to the second support column 32 by the joint 39, and when the gripper housing 40 is capable of turning in the vertical direction and in the width direction with respect to the distal-end portion (the distal-end portion 33) of the slide rod 37 (the first support column 31) by the joint 44 (including a case where the turning rod 36 of the first support column 31 is coupled to the second support column 32 turnably in the vertical direction and in the width direction, and the gripper housing 40 is fixed to the distal-end portion (the distal-end portion 33) of the slide rod 37 (the first support column 31) unturnably or where the turning rod 36 of the first support column 31 is fixed to the second support column 32 unturnably in the vertical direction or in the width direction, and the rear surface (the rear portion) of the gripper housing 40 of the vacuum gripper 34 is coupled to the distal-end portion (the distal-end portion 33) of the slide rod 37 (the first support column 31) turnably in the vertical direction and in the width direction), even if the work gondola 10A suspended in the air makes a swing motion (swings) due to an influence of winds or works, the swing is absorbed by the joint 39 and the joint 44 and thus, the swing does not directly act on the vacuum gripper 34, and unexpected separation of the suction surface 43 of the gripper 34 from the outer wall 12 of the building 11 due to the action of the swing on the gripper 34 can be prevented.

In the vacuum gripper 34 to which the vacuum pads 42 are attached, after the gripper 34 is attached to the outer wall 12, the turning rod 36 of the first support column 31 is fixed to the second support column 32 by the fixing fixture (not shown) unturnably so as to have the turning rod 36 as a fixed rod unable to turn, and the gripper housing 40 is fixed to the distal-end portion (the distal-end portion 33) of the slide rod 37 (the first support column 31) by the fixing fixture (not shown) unturnably in some cases. In this case, by increasing the attaching force (the suctioning force) of the vacuum gripper 34 so as to have the suction surface 43 (the vacuum pads 42) of the gripper 34 strongly attached to the outer wall 12 of the building 11, since the work gondola 10A is coupled to the outer wall 12 of the building 11 by the suction attachment device 63, unable to swing, even if there is an influence of winds or works, the gondola 10A does not swing or move but the stationary state of the work gondola 10A in the air is held.

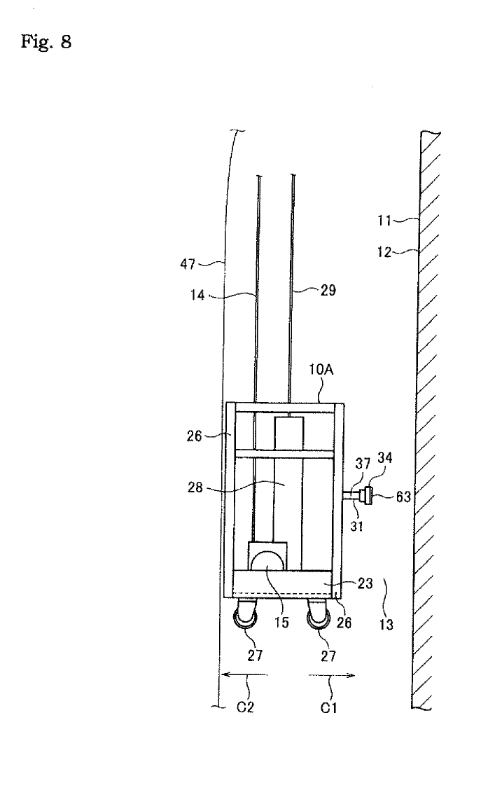

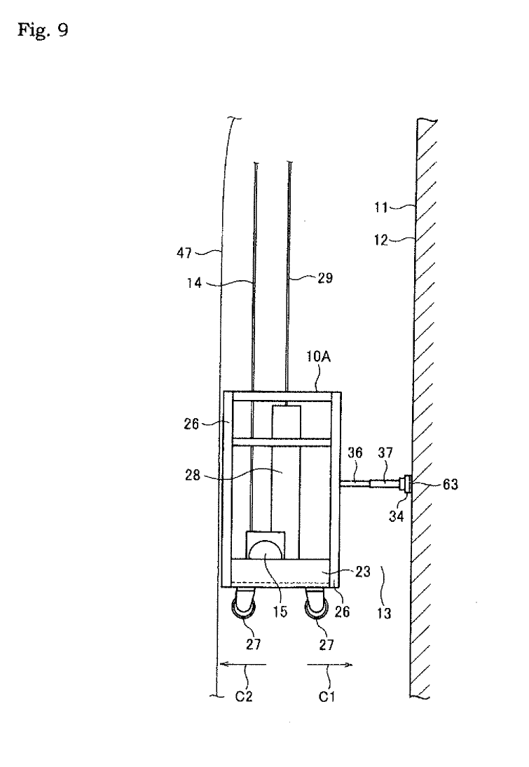

FIG. 8 is a side view of the work gondola 10A before being coupled to the outer wall 12 of the building 11, and FIG. 9 is a side view of the work gondola 10A after being coupled to the outer wall 12 of the building 11. FIG. 8 illustrates a state before the vacuum gripper 34 is attached to the outer wall 12 of the building 11, and FIG. 9 illustrates a state after the vacuum gripper 34 is attached to the outer wall 12 of the building 11. In FIGS. 8 and 9, illustration of the vacuum hose 90 is omitted. In FIGS. 8 and 9, a net cover 47 is spread from the rooftop of the building 11 toward the ground, and the gondola 10A is disposed between the net cover 47 and the building 11. The net cover 47 is a mesh net made of a synthetic resin and prevents scattering of the solid wastes such as concrete debris, mortar debris, tile debris and the like generated by the construction works to the outer wall 12 of the building 11 to the periphery.

An example of a procedure for performing various construction works to the outer wall of the building by using the work gondola 10A is as follows. It is to be noted that it is assumed that the second support column 32 has been already fixed to the reinforcing support 26 by the coupling fixture. As illustrated in FIG. 8, it is assumed that the gondola 10A is suspended from the rooftop of the building 11 by the elevating device (the hoisting accessory, the hoisting wire rope 14, the hoisting machine 15), and a worker (not shown) prepares for the construction work. When the worker gets on the gondola 10A having been descended on the ground and presses a rise button (rise ON) of the pendant switch 30, the hoisting machine 15 is started, and the gondola 10A gradually ascends from the ground toward the rooftop of the building 11.

After the work gondola 10A has been ascended to a construction work site on the outer wall 12 of the building 11, the worker presses a stop button of the pendant switch 30 and stops the gondola 10A. Subsequently, after the turning rod 36 of the first support column 31 is moved to the width direction of the second support column 32 so as to position the first support column 31 with respect to the second support column 32, the turning rod 36 of the first support column 31 is fixed to the second support column 32. After the turning rod 36 of the first support column 31 is fixed to the second support column 32, the slide rod 37 is slid to the front in the front-rear direction from the turning rod 36 so as to extend the first support column 31 until the suction port 46 (the sealing foam 41 or the vacuum pad 42) of the vacuum gripper 34 is brought into contact with the outer wall 12 of the building 11. At a position where the suction port 46 (the sealing foam 41 or the vacuum pad 42) of the vacuum gripper 34 is brought into contact with the outer wall 12, the slide rod 37 is fixed to the turning rod 36 by the slide stopper (the slide fixing mechanism), and the length dimension of the first support column 31 is matched with the distance of the space 13 in the front-rear direction.

After the length dimension of the first support column 31 is matched with the distance of the space 13, a suction start button of the pendant switch 30 is pressed (suction ON). When the suction start button is pressed, the vacuum pump 35 is started (the compressed air is supplied to the compressed air generating device in the built-in type), and the suction port 46 (the suction hole 46 of the sealing foam 41 or the vacuum pad 42) of the vacuum gripper 34 is brought into the vacuum state by the pump 35 (or the compressed air generating device), the suction surface 46 of the gripper 34 is attached to the outer wall 12 of the building 11, and the gondola 10A is coupled (fixed) to the outer wall 12 by the suction attachment device 63.

It is to be noted that after the gondola 10A is coupled/fixed to the outer wall 12 of the building 11 by the suction attachment device 63 or before the gondola 10A is coupled to the outer wall 12 of the building 11 by the suction attachment device 63, the first support column 31 is unturnably fixed to the second support column 32, and the gripper housing 40 of the vacuum gripper 34 is unturnably fixed to the slide rod 37 in some cases. When the first support column 31 is fixed to the second support column 32 and the gripper housing 40 of the vacuum gripper 34 is fixed to the slide rod 37 before the gondola 10A is coupled/fixed to the outer wall 12 of the building 11 by the suction attachment device 63, if the outer wall 12 is a perpendicular surface or if the outer wall 12 is an inclined surface, the first support column 31 is turned with respect to the second support column 32 by using the joint 39, and the gripper housing 40 is turned with respect to the slide rod 37 by using the joint 44 so that the suction surface 43 of the vacuum gripper 34 is made in parallel with the perpendicular surface or the inclined surface of the outer wall 12 of the building 11 and then, the first support column 31 is unturnably fixed to the second support column 32, and the gripper housing 40 of the vacuum gripper 34 is unturnably fixed to the slide rod 37.

If the gripper housing 40 is unturnably fixed to the distal-end portion of the slide rod 37, the first support column 31 is turned with respect to the second support column 32 by using the joint 39 so that the suction surface 43 of the vacuum gripper 34 is made in parallel with the perpendicular surface or the inclined surface of the outer wall 12 of the building 11 and then, the first support column 31 is unturnably fixed to the second support column 32. Moreover, when the first support column 31 is unturnably fixed to the second support column 32, the gripper housing 40 is turned with respect to the slide rod 37 by using the joint 44, and the suction surface 43 of the vacuum gripper 34 is made in parallel with the perpendicular surface or the inclined surface of the outer wall 12 of the building 11 and then, the gripper housing 40 is unturnably fixed to the slide rod 37.

After the gondola 10A is coupled/fixed to the outer wall 12 of the building 11 by the suction attachment device 63 or before the gondola 10A is coupled to the outer wall 12 of the building 11 by the suction attachment device 63, the first support column 31 is not unturnably fixed to the second support column 32 but the first support column 31 is made turnable with respect to the second support column 32 by the joint 39, and the gripper housing 40 of the vacuum gripper 34 is made turnable with respect to the slide rod 37 by the joint 44 in some cases. In this case, if the outer wall 12 is a perpendicular surface or if the outer wall 12 is an inclined surface, the first support column 31 is turned with respect to the second support column 32 by the joint 39, and the gripper housing 40 is turned with respect to the slide rod 37 by the joint 44 so that the parallel state of the suction surface 43 of the vacuum gripper 34 with respect to the perpendicular surface or the inclined surface of the outer wall 12 is held.

If the gripper housing 40 is unturnably fixed to the distal-end portion of the slide rod 37, by means of turning of the first support column 31 with respect to the second support column 32 by the joint 39, the parallel state of the suction surface 43 of the vacuum gripper 34 with respect to the perpendicular surface or the inclined surface of the outer wall 12 is held. Moreover, if the first support column 31 is unturnably fixed to the second support column 32, by means of turning of the gripper housing 40 with respect to the slide rod 37 by the joint 44, the parallel state of the suction surface 43 of the vacuum gripper 34 with respect to the perpendicular surface or the inclined surface of the outer wall 12 is held.

In the work gondola 10A, since the gondola 10A is coupled/fixed to the outer wall 12 by the vacuum device (the vacuum gripper 34) attached to the outer wall 12 (the outer surface) of the building 11 (the structure), the gondola 10A does not swing or move (does not swing) due to the influence of winds or works but the gondola 10A is made stationary in the air, and the attitude of the gondola 10A in the air is made stable. In a state where the gondola 10A and the outer wall 12 of the building 11 are connected by the vacuum gripper 34, the worker reaches his/her hand to the space 13 between the outer wall 12 of the building 11 and the gondola 10A from the front portion 16 of the gondola 10A and performs the various construction works to the outer wall 12 by using various electric tools or manual tools and the like.

After the construction work at the construction work site on the outer wall 12 of the building 11 is completed, the suction stop button of the pendant switch 30 is pressed (suction OFF). When the suction stop button is pressed, the vacuum pump 35 is stopped (the supply of the compressed air to the compressed air generating device is stopped in the built-in type), and the attachment of the suction surface 43 (the sealing foam 41 or the vacuum pad 42) of the vacuum gripper 34 to the outer wall 12 is released. Fixing of the slide rod 37 to the turning rod 36 is released, and the slide rod 37 is slid to the rear in the front-rear direction of the turning rod 36 so as to contract the first support column 31 and then, the slide rod 37 is fixed to the turning rod 36 by the slide stopper (the slide fixing mechanism). The rise button or the lowering button of the pendant switch 30 is pressed so as to raise or lower the gondola 10A to the subsequent construction work site, and the works are performed at the construction work site by using the suctioning means.

In the work gondola 10A, since the gondola 10A is coupled/fixed to the outer wall 12 by the vacuum gripper 34 attached to the outer wall 12 (the outer surface) of the building 11 (the structure), the gondola 10A does not swing or move (does not swing) but the gondola 10A can be made stationary in the air, and the attitude of the gondola 10A in the air can be made stable. In the gondola 10A, since the worker can perform a predetermined work in the state made stationary by the suction attachment device 63, the works involved in the various construction works can be performed accurately and reliably. With the gondola 10A, operations using it does not involve dangers but the operations can be proceeded with safely, and swing of the gondola 10A does not have to be made stationary each time or the worker does not have to perform a manipulation for maintaining the stationary state of the gondola 10A, whereby the construction works can be proceeded with rapidly and efficiently.

In the work gondola 10A, since the suction port 46 (the suction hole 45 of the sealing foam 41 or the vacuum pad 42) of the vacuum gripper 34 is brought into the vacuum state by the vacuum pump 35 (the compressed air in the built-in type), the vacuum gripper 34 exerts a strong suctioning force, and the gondola 10A can be fixed to the outer wall 12 of the building 11 reliably by the vacuum gripper 34.

In the work gondola 10A, when the sealing foam 41 having a plurality of the suction holes 45 and having a predetermined area and a predetermined thickness with flexibility is installed on the suction surface 46 of the vacuum gripper 34, even if the outer wall 12 of the building 11 is an irregular surface, the flexible sealing foam 41 with a predetermined area and a predetermined thickness follows the irregularity and its thickness is changed (elastically deformed) and since the plurality of suction holes 45 is attached to the irregular surface, the vacuum gripper 34 is attached to the irregular surface of the outer wall 12 reliably, and the gondola 10A can be fixed to the irregular surface of the outer wall 12 reliably.

In the work gondola 10A, when the plurality of elastically deformable vacuum pads 42 is installed on the suction surface 46 of the vacuum gripper 34, even if the outer wall 12 of the building 11 is an irregular surface, the plurality of vacuum pads 42 follows the irregularity and is elastically deformed, and those vacuum pads 42 are attached to the irregular surface and thus, the vacuum gripper 34 is attached to the irregular surface of the outer wall 12 reliably, and the gondola 10A can be fixed to the irregular surface of the outer wall 12 reliably.

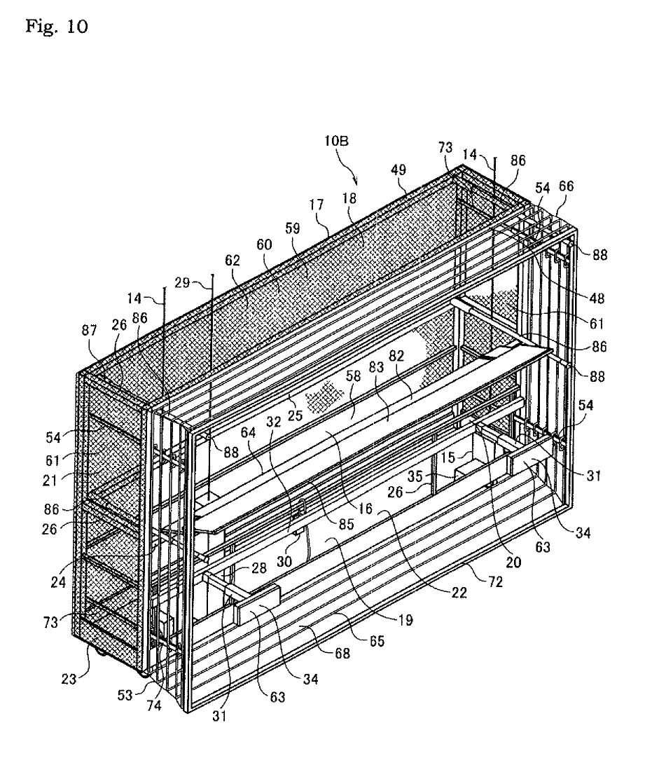

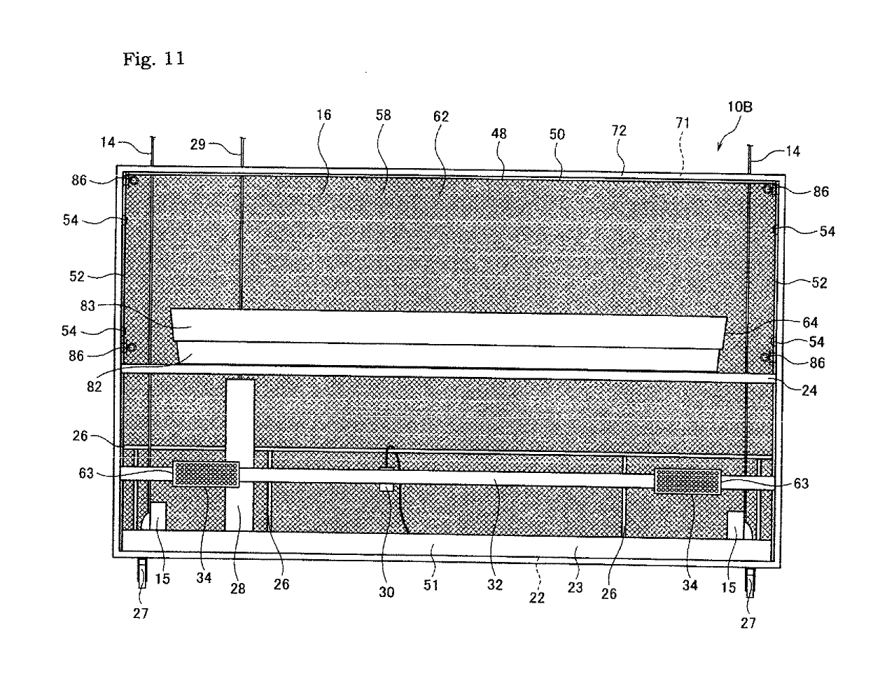

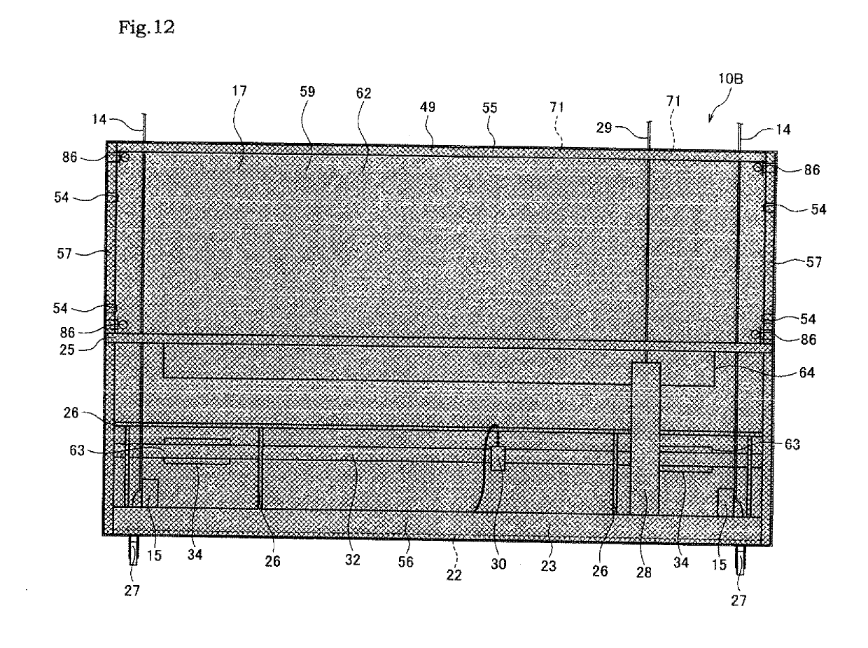

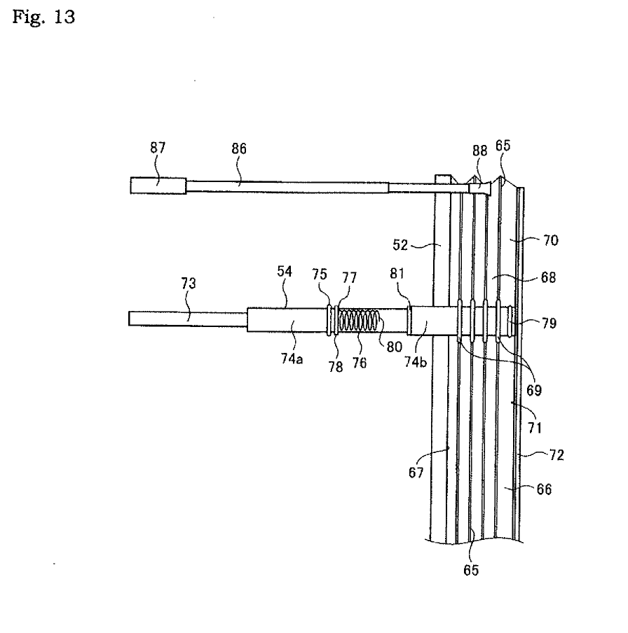

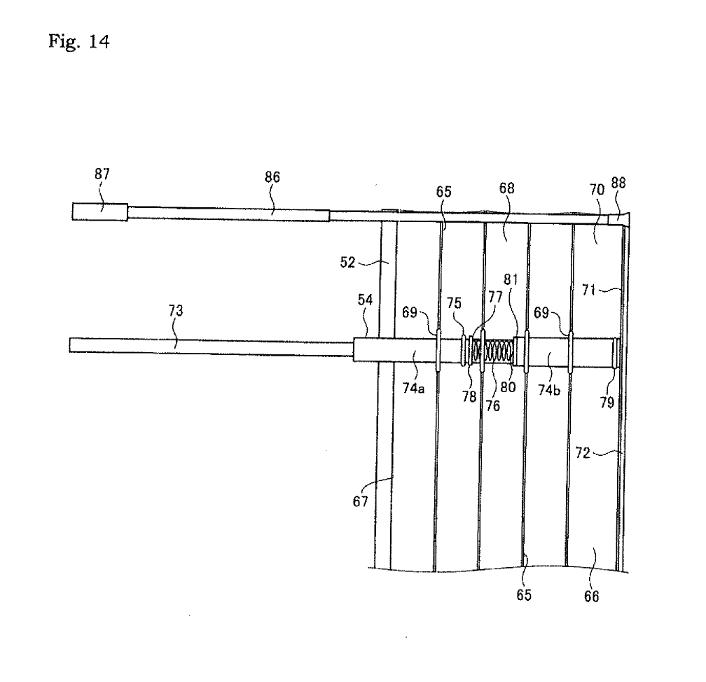

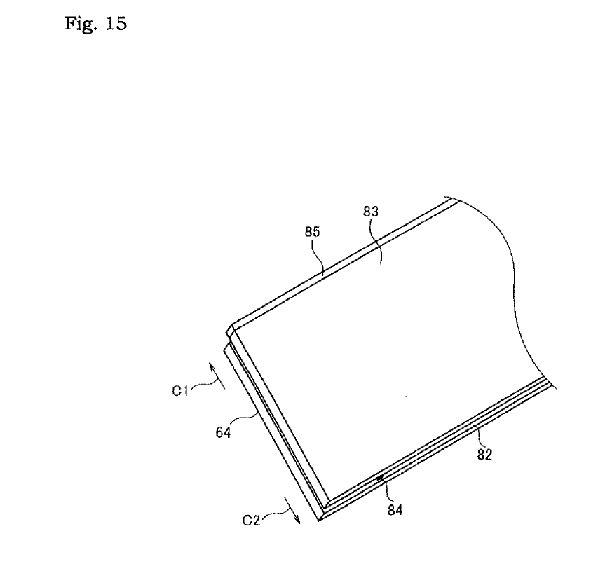

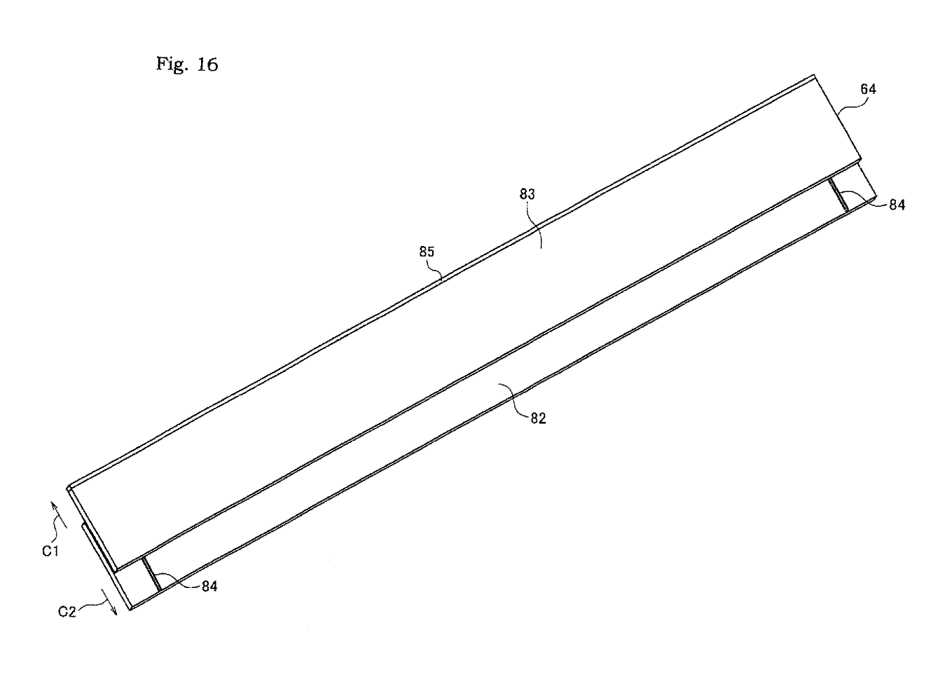

FIG. 10 is a perspective view of a work gondola 10B illustrated as another example, and FIG. 11 is a front view of the work gondola 10B. FIG. 12 is a rear view of the work gondola 10B, and FIG. 13 is a partially enlarged side view of a cover sheet 53 before being extended, a slide rail 54, and an extension/contraction rod 86. FIG. 14 is a partially enlarged side view of the cover sheet 53 after being extended, the slide rail 54, and the extension/contraction rod 86, and FIG. 15 is a partially enlarged perspective view of a fall-preventing plate 64 before being extended. FIG. 16 is a partially enlarged perspective view of the fall-preventing plate 64 after being extended.

In FIG. 10, a part of illustration of the net cover 62 is omitted. In FIGS. 10 to 12, illustration of the vacuum hose 89 is omitted. FIG. 11 illustrates a state where the fall-preventing plate 64 is extended, and FIG. 12 illustrates a state where the fall-preventing plate 64 is suspended. In FIG. 10, the vertical direction is indicated by the arrow A, the width direction is indicated by the arrow B, and the front-rear direction is indicated by the arrow C. In FIGS. 13 to 16, the front in the front-rear direction is indicated by the arrow C1, and the rear in the front-rear direction is indicated by the arrow C2.

This work gondola 10B is different from that in FIG. 1 in points that the work gondola 10B has a front frame 48 and a rear frame 49, the cover sheet 53 is attached to the front frame 48, the slide rail 54 for extending/contracting the cover sheet 53 in the front-rear direction is installed, and the fall-preventing plate 64 and the extension/contraction rod 86 are installed. Since the other constitutions of the gondola 10B are the same as those in the gondola 10A in FIG. 1, the same reference numerals as those in FIG. 1 are given, and by employing the description of the gondola 10A in FIG. 1 by analogy, detailed description of the other constitutions of the gondola 10B is omitted.

The work gondola 10B is, similarly to that in FIG. 1, used in order to ensure a safe scaffold in a high-place work when various construction works are performed to the building 11 (the structure). The gondola 10B is disposed on the outer side of the outer wall 12 of the building 11 and is suspended from the rooftop of the building 11 by the elevating device (the hoisting accessory, the hoisting wire rope 14, the hoisting machine 15), capable of elevating in the vertical direction. The gondola 10B has the front portion 16, the rear portion 17, the top portion 18, the bottom portion 19, the center portion 20, and the both side portions 21.

The work gondola 10B is made by the floor material 22 installed on the bottom portion 19 and having a predetermined area, the bottom frame 23 (the floor material support plate) supporting the floor material 22, the front frame 48 (the front frame) installed on the front portion 16, the rear frame 49 (the rear frame) installed on the rear portion 17, the front handrail 24 (the front handrail) and the rear handrail 25 (the rear handrail) located above (the top portion 18) of the floor material 22 and extending in the width direction, and a plurality of the reinforcing columns 26 coupled to the frames 48 and 49, the front handrail 24, and the rear handrail 25.

The floor material 22, the bottom frame 23, the front handrail 24, the rear handrail 25, and the reinforcing column 26 are the same as those in the gondola 10A in FIG. 1. The bottom frame 23, the front frame 48, the rear frame 49, the front handrail 24, the rear handrail 25, and the reinforcing column 26 are coupled by welding. In the gondola 10B, a work space surrounded by the floor material 22, the floor frame 23, the front frame 48, the rear frame 49, the front handrail 24, the rear handrail 25, and the reinforcing column 26 is defined. It is to be noted that the shape of the work gondola 10B is not limited to the illustration, but a gondola having any shape can be used.

The front frame 48 is formed by an upper front rod 50 (the upper rod) (square columnar pipe) located on the top portion 18 of the gondola 10B and extending in the width direction, a lower front rod 51 (the lower rod) (square columnar pipe) located on the bottom portion 19 of the gondola 10B and extending in the width direction, and both-side front rods 52 (the both side rods) (square columnar pipe) located on the both side portions 21 of the gondola 10B and extending in the vertical direction between the upper and lower front rods 50 and 51. On the front frame 48 (the upper and lower front rods 50 and 51, and the both-side front rods 52), the cover sheet 53 is attached. On upper parts and lower parts of the both-side front rods 52, the slide rail 54 extending in the front-rear direction is installed. It is to be noted that the slide rail 54 may be installed on the both side portions of the upper and lower front rods 50 and 51.

The rear frame 49 has substantially the same shape and size as those of the front frame 48 and is formed by an upper rear rod 55 (the upper rod) (square columnar pipe) located on the top portion 18 of the gondola 10B and extending in the width direction, a lower rear rod 56 (the lower rod) (square columnar pipe) located on the bottom portion 19 of the gondola 10B and extending in the width direction, and both side rear rods 57 (the both side rods) (square columnar pipes) located on the both side portions 21 of the gondola 10B and extending in the vertical direction between the upper and lower rear rods 55 and 56. A height dimension in the vertical direction of the front frame 48 or the rear frame 49 is preferably higher than a height of a worker on the gondola 10B (the floor material) and within a range from 175 to 200 cm.

On the front portion 16 of the work gondola 10B, a front-surface opening 58 surrounded by the front frame 48 and having a predetermined area is defined, and on the rear portion 17, a rear-surface opening 59 surrounded by the rear frame 49 and having a predetermined area is defined. On the top portion 18, a top-surface opening 60 surrounded by the upper front rod 50, the upper rear rod 55, and the reinforcing column 26 and having a predetermined area is defined, and on the both side portions 21, both-side openings 61 surrounded by the both-side front rods 52, the both side rear rods 57 and the reinforcing column 26 and having a predetermined area, respectively, are defined. On the entire region of the rear-surface opening 59, the entire region of the top-surface opening 60, and the entire regions of the both-side openings 61, the net cover 62 is installed, and those openings 59 to 61 are covered by the net cover 62. For the net cover 62, a mesh net made of a synthetic resin is used.

On the front portion 16 of the work gondola 10B, the suction attachment device 63 which couples (fixes) the gondola 10B to the building while being attached to the outer wall 12 of the building 11 (the gondola 10B is made stationary in the air) is installed. The suction attachment device 63 is the same as that installed on the gondola 10A in FIG. 1 and is formed by the two first support columns 30 (the turning rod 36 and the slide rod 37) extending in the front-rear direction from the front portion 16 of the gondola 10B, the one second support column 31 installed on the front portion of the gondola 10B (installed on the both-side front rods 52 of the front frame 48) and extending in the width direction, two units of the vacuum grippers 34 mounted on the distal-end portions 33 of the first support columns 30 (the slide rods 37), and the vacuum pump 35 (or the compressed air generating device) connected to those vacuum grippers 34. The vacuum gripper 34 and the vacuum pump 35 are connected through the vacuum hose 89.

It is to be noted that the number of units of the vacuum grippers 34 is not limited, and one unit of the vacuum gripper 34 or three or more units of the vacuum grippers 34 are installed on the gondola 10B depending on a size of the gondola 10B (the width dimension or the vertical dimension) in some cases. Since the first and second support columns 30 and 31, the vacuum gripper 34, and the vacuum pump 35 are the same as those in the gondola 10A in FIG. 1, the same reference numerals as those in FIG. 1 are given, and by employing the description in FIG. 1 by analogy, description thereof is omitted.

On the front handrail 24, the fall-preventing plate 64 extending in the width direction is installed. Below each corner part of the bottom frame 23, the caster 27 is mounted. On the floor material 22 on the both side portions 21 of the gondola 10B, the hoisting machine 15 to which the hoisting wire rope 14 is connected is installed/fixed, and on the floor material 22 on one of the side portions 21 of the gondola 10B, the control panel 28 for gondola is placed/fixed. To the control panel 28 for gondola, the power cable 29 suspended from the rooftop of the building 11 is connected, and electricity is supplied to each of the hoisting machines 15 from the control panel 28 by the power cable (not shown). On the reinforcing column 26, the pendant switch 30 connected to the control panel 28 for gondola through the cable is hooked.

The cover sheet 53 surrounds the entire region of the front frame 48 (the entire region of the front-surface opening 58) of the gondola 10B and is installed on the top portion 18, the bottom portion 19, and the both side portions 21 of the gondola 10A. The cover sheet 53 is located in the space 13 between the front frame 48 (the front-surface opening 58) and the outer wall 12 of the building 11 and extends in the front-rear direction from the front frame 48 when the gondola 10A is suspended on the outer side of the outer wall 12 of the building 11. The cover sheet 53 is formed by a plurality of bellows frames 65 located on the space 13 and arrayed in the front-rear direction and a bellows sheet 66 mounted on the bellows frames 65 and extending in the front-rear direction.

The bellows frames 65 have substantially the same shape and size of those of the front frame 48 and is made of a synthetic resin or metal. The bellows sheet 66 is made of a colorless and transparent synthetic resin sheet having predetermined strength but it may be made of a colored and transparent or colored synthetic resin sheet having predetermined strength, screen mesh, stainless mesh, cloth or the like. It is to be noted that, for the cover sheet 53, other than the bellows frame 65 or the bellows sheet 66, a synthetic resin sheet, screen mesh, stainless mesh, cloth or the like not folded into a bellows may be used.

The bellows sheet 66 has a fixed portion 67 fixed to the upper and lower front rods 50 and 51 and the both-side front rods 52 (the front frames 48) and an extension/contraction portion 68 extending to the front in the front-rear direction from the fixed portion 67. The extension/contraction portion 68 is folded into a bellows in the front-rear direction between those bellows frames 65 and is capable of extending/contracting in the front-rear direction in the space 13. The extension/contraction portion 68 has a non-extended state where it is not extended to the front in the front-rear direction and an extended state where it is extended to the front in the front-rear direction.

On the extension/contraction portion 68 of the bellows sheet 66 located on an upper part and a lower part of the both-side front rods 52, a plurality of runner rings 69 made of metal and arrayed in the front-rear direction at a predetermined interval (an equal interval) is mounted. On a front end portion 70 (a front end portion) of the extension/contraction portion 68 of the bellows sheet 66 faced with the outer wall 12 of the building 11, a contact frame 71 made of metal or made of a synthetic resin and a contact member 72 having cushioning characteristics (flexibility) and a predetermined area and a predetermined thickness are mounted. The contact member 72 surrounds the entire region of the front frame 48 (the entire region of the front-surface opening 58) of the gondola 10B and is in surface contact with the outer wall 12 of the building 11. For the contact member 72, foamed plastic such as soft polyurethane foam, polystyrene foam, polyethylene foam, polypropylene foam, EVA crosslinked foamed body and the like or a silicone resin can be used.

The slide rail 54 is formed by a fixed rail 73 installed on/fixed to an upper and lower parts of the both-side front rods 52 and the upper and the lower parts of the both-side rear rods 57 by a fixing fixture (not shown), a first movable rail 74a slidable in the front-rear direction from the fixed rail 73, and a second movable rail 74b slidable in the front-rear direction from the first movable rail 74a. The first and second movable rails 74a and 74b are inserted into the runner rings 69 mounted on the extension/contraction portion 68 of the bellows sheet 66, and a distal-end portion of the second movable rail 74b is fixed to the front end portion 70 of the bellows sheet 66 by a fixing fixture (not shown).

Those slide rails 54 include a slide stopper (a slide fixing mechanism) (not shown) which fixes the first movable rail 74a at a predetermined position on the fixed rail 73 in the state where the first and second movable rails 74a and 74b are extended so as to disable slide (an extension/contraction) of the first movable rails 74ab and to fix the first and second movable rails 74a and 74b at a predetermined position on the fixed rail 73 in the state where the first and second movable rails 74a and 74b are contracted so as to disable slide (extension/contraction) of the first and second movable rails 74a and 74b.

At the distal-end portion of the first movable rail 74a, a handle 75 capable of gripping and sliding the first movable rail 74a in the front-rear direction is mounted, and a coil spring 76 extending in the front-rear direction is mounted. The coil spring 76 has its rear end portion 77 fixed to a spring receiving plate 78 installed on the distal-end portion of the first movable rail 74a and extends to the front in the front-rear direction from the spring receiving plate 78. On the distal-end portion of the second movable rail 74b, a handle 79 capable of gripping and sliding the second movable rail 74b to the front-rear direction is mounted, and a spring contact plate 81 with which a front end portion 80 of the coil spring 76 is brought into contact is installed.

In the slide rail 54, by gripping the handle 75 of the first movable rail 74a and sliding the first movable rail 74a to the front in the front-rear direction, the front end portion 80 of the coil spring 76 is brought into contact with the spring contact plate 81 installed on the distal-end portion of the second movable rail 74b, and the second movable rail 74b is pressed by the coil spring 76 and slides to the front and as illustrated in FIG. 14, the bellows sheet 66 can be extended to the front, and the length dimension of the bellows sheet 66 in the front-rear direction can be made longer. On the contrary, by gripping the handle 79 of the second movable rail 74b and by sliding the second movable rail 74b to the rear in the front-rear direction, as illustrated in FIG. 13, the bellows sheet 66 can be contracted to the rear, and the length dimension of the bellows sheet 66 in the front-rear direction can be made shorter.

After the first and second movable rails 74a and 74b are slid to the front in the front-rear direction, by fixing the first movable rail 74a to the fixed rail 73 by the slide stopper (the slide fixing mechanism), the state where the extension/contraction portion 68 of the bellows sheet 66 is extended to the front in the front-rear direction can be maintained. At this time, the second movable rail 74b is pressed (urged) to the front in the front-rear direction by the coil spring 76. After the first and second movable rails 74a and 74b are slid to the rear in the front-rear direction, by fixing the first and second movable rails 74a and 74b to the fixed rail 73 by the slide stopper (the slide fixing mechanism), the state where the extension/contraction portion 68 of the bellows sheet 66 is contracted to the rear in the front-rear direction can be maintained. By extending/contracting the bellows sheet 66 by using the first and second movable rails 74a and 74b, the length dimension of the bellows sheet 66 can be adjusted in accordance with the distance of the space 13 in the front-rear direction.

The fall-preventing plate 64 is formed by a turning plate 82 and a slide plate 83. The turning plate 82 has its base-end portion installed on a mounting ring (turning mechanism) (not shown) or a hinge (a turning mechanism) (not shown) mounted on the front handrail 24. The turning plate 82 is turnable in the vertical direction around its base-end portion (the front handrail 24) by the mounting ring or the hinge.

The slide plate 83 is, as illustrated in FIG. 16, coupled to the turning plate 82 by a slide rail 84 extending in the front-rear direction. The slide plate 83 is slidable in the front-rear direction through the slide rail 84 and is capable of extension/contraction in the front-rear direction from the turning plate 82. A front end portion of the slide plate 83 faced with the outer wall 12 of the building 11, a contact member 85 having cushioning characteristics (flexibility) and a predetermined area and a predetermined thickness is mounted. The contact member 85 is the same as that mounted on the front end portion 70 of the extension/contraction portion 68 in the bellows sheet 66 and is in surface contact with the outer wall 12 of the building 11.

The fall-preventing plate 64 (the turning plate 82 and the slide plate 83) is in the suspended state extending downward with respect to the front handrail 24 when not in use. In the fall-preventing plate 64 (the turning plate 82 and the slide plate 83), it can be turned from the suspended state to a range of 180° upward. The fall-preventing plate 64 includes a turning stopper (the turning (inclination) fixing mechanism) (not shown) which fixes a turning angle of the turning plate 82 at a predetermined angle and disables turning of the plate 64. In the fall-preventing plate 64, by turning the turning plate 82, the turning angle (an inclination angle) of the plate 64 can be adjusted, and by turning the turning plate 82 upward and by inclining the fall-preventing plate 40 with an ascending gradient and then, by fixing the turning plate 82 by the turning stopper (the turning (inclination) fixing mechanism), the inclined state with the ascending gradient at a predetermined angle of the plate 64 can be maintained.

The fall-preventing plate 64 includes a slide stopper (a slide fixing mechanism) (not shown) which fixes the slide plate 83 at a predetermined position of the turning plate 82 and disables slide (extension/contraction) of the slide plate 83. In the fall-preventing plate 64, by sliding the slide plate 83 to the front in the front-rear direction by using the slide rail 84, as illustrated in FIG. 16, the fall-preventing plate 64 (the slide plate 83) can be extended to the front in the front-rear direction, and the length dimension of the plate 64 in the front-rear direction can be made longer. On the contrary, by sliding the slide plate 83 to the rear in the front-rear direction by using the slide rail 84, as illustrated in FIG. 15, the fall-preventing plate 64 (the slide plate 83) can be contracted to the rear in the front-rear direction, and the length dimension of the plate 64 in the front-rear direction can be made shorter.

After the slide plate 83 is slid to the front in the front-rear direction, by fixing the slide plate 83 to the turning plate 82 by the slide stopper (the slide fixing mechanism), the state where the fall-preventing plate 64 (the slide plate 83) is extended to the front in the front-rear direction can be maintained, and after the slide plate 83 is slid to the rear in the front-rear direction, by fixing the slide plate 83 to the turning plate 82 by the slide stopper (the slide fixing mechanism), the state where the plate 64 (the slide plate 83) is contracted to the rear in the front-rear direction can be maintained. By extending/contracting the fall-preventing plate 64 in the front-rear direction by using the slide plate 83, the length dimension of the plate 64 can be adjusted in accordance with the distance of the space 13 in the front-rear direction.

For the extension/contraction rod 86, a tension rod is used, but other than the tension rod, the extension/contraction rod 86 formed by an outer rod and an inner rod accommodated in the outer rod, capable of being extended/contracted, the inner rod being urged to the front in the front-rear direction by a coil spring accommodated in the outer rod can be used. The extension/contraction rod 86 is detachably disposed at a first corner part where the upper front rod 50 and the both-side front rods 52 cross each other and a center portion in the vertical direction of the both-side front rods 52 and extends in the front-rear direction from the first corner part and the center portion. It is to be noted that the extension/contraction rod 86 may be detachably disposed at the second corner part where the lower front rod 51 and the both-side front rods 52 cross each other and extend in the front-rear direction from the second corner part.

Those extension/contraction rods 86 have their base-end portions 87 installed on/fixed to the upper rear rod 55 and the both-side rear rods 57 by a fixing fixture (not shown). When the extension/contraction rod 86 is extended to the front in the front-rear direction, as illustrated in FIG. 14, its distal-end portion 88 is brought into contact with the front end portion 70 in extension of the extension/contraction portion 68 of the bellows sheet 66, and the contact state of the front end portion 70 with the outer wall 12 of the building 11 in the extension of the extension/contraction portion 68 is maintained.

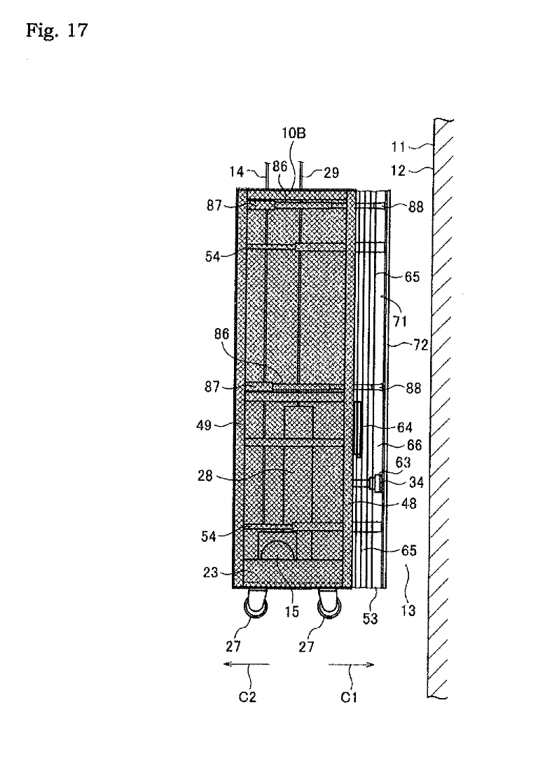

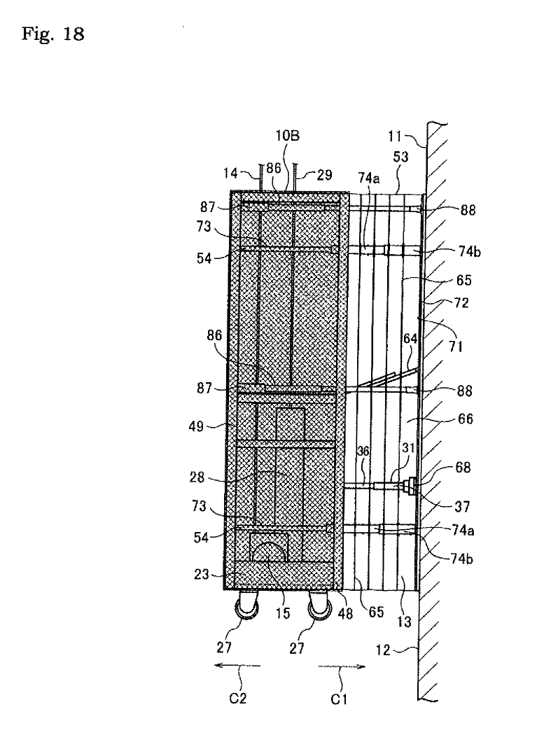

FIG. 17 is a side view of the work gondola 10B before being coupled to the outer wall 12 of the building 11, and FIG. 18 is a side view of the work gondola 10B after being coupled to the outer wall 12 of the building 11. FIG. 17 illustrates a state before the vacuum gripper 34 is attached to the outer wall 12, and FIG. 18 illustrates a state after the vacuum gripper 34 is attached to the outer wall 12. In FIGS. 17 and 18, illustration of the vacuum hose 89 is omitted. An example of a procedure for performing various construction works to the outer wall 12 of the building 11 by using the work gondola 10B is as follows. It is to be noted that it is assumed that the second support column 32 has been already fixed to the both-side front rods 52 by a fixing fixture.

After the work gondola 10B has been ascended to a construction work site on the outer wall 12 of the building 11, the stop button of the pendant switch 30 is pressed so as to stop the gondola 10B. Subsequently, after the turning rod 36 of the first support column 31 is moved to the width direction of the second support column 32 so as to position the first support column 31 with respect to the second support column 32, the turning rod 36 of the first support column 31 is fixed to the second support column 32. After the turning rod 36 of the first support column 31 is fixed to the second support column 32, the slide rod 37 is slid to the front in the front-rear direction from the turning rod 36 so as to extend the first support column 31 until the suction port 46 (the sealing foam 41 or the vacuum pad 42) of the vacuum gripper 34 is brought into contact with the outer wall 12 of the building 11. At a position where the suction port 46 (the sealing foam 41 or the vacuum pad 42) of the vacuum gripper 34 is brought into contact with the outer wall 12, the slide rod 37 is fixed to the turning rod 36 by the slide stopper (the slide fixing mechanism), and the length dimension of the first support column 31 is matched with the distance of the space 13.

After the length dimension of the first support column 31 is matched with the distance of the space 13, a suction start button of the pendant switch 30 is pressed (suction ON). When the suction start button is pressed, the vacuum pump 35 is started (the compressed air is supplied to the compressed air generating device in the built-in type), and the suction port 46 (the suction hole 45 of the sealing foam 41 or the vacuum pad 42) of the vacuum gripper 34 is brought into the vacuum state by the pump 35 (or the compressed air generating device), the suction surface 43 of the vacuum gripper 34 is attached to the outer wall 12 of the building 11, and the gondola 10B is coupled (fixed) to the outer wall 12 by the suction attachment device 63.

It is to be noted that after the gondola 10B is coupled/fixed to the outer wall 12 of the building 11 by the suction attachment device 63 or before the gondola 10B is coupled/fixed to the outer wall 12 by the suction attachment device 63, the first support column 31 is unturnably fixed to the second support column 32, and the gripper housing 40 of the vacuum gripper 34 is unturnably fixed to the slide rod 37 in some cases. When the first support column 31 is fixed to the second support column 32 and the gripper housing 40 of the vacuum gripper 34 is fixed to the slide rod 37 before the gondola 10B is coupled to the outer wall 12 of the building 11 by the suction attachment means, if the outer wall 12 is a perpendicular surface or if the outer wall 12 is an inclined surface, the first support column 31 is turned with respect to the second support column 32 by using the joint 39, and the gripper housing 40 is turned with respect to the slide rod 37 by using the joint 44 so that the suction surface 43 of the vacuum gripper 34 is made in parallel with the perpendicular surface or the inclined surface of the outer wall 12 and then, the first support column 31 is unturnably fixed to the second support column 32, and the gripper housing 40 is unturnably fixed to the slide rod 37.

After the gondola 10A is coupled/fixed to the outer wall 12 of the building 11 by the suction attachment device 63 or before the gondola 10A is coupled/fixed to the outer wall 12 by the suction attachment device 63, the first support column 31 is not unturnably fixed to the second support column 32 but the first support column 31 (the turning rod 36) is made turnable with respect to the second support column 32 by the joint 39, and the gripper housing 40 of the vacuum gripper 34 is made turnable with respect to the slide rod 37 by the joint 44 in some cases. In this case, if the outer wall 12 is a perpendicular surface or if the outer wall 12 is an inclined surface, the first support column 31 is turned with respect to the second support column 32, and the gripper housing 40 is turned with respect to the slide rod 37 by the joint 44 so that the parallel state of the suction surface 43 of the vacuum gripper 34 with the perpendicular surface or the inclined surface of the outer wall 12 is held.

If the gripper housing 40 is unturnably fixed to the distal-end portion of the slide rod 37, by means of turning of the first support column 31 with respect to the second support column 32 by the joint 39, the parallel state of the suction surface 43 of the vacuum gripper 34 with the perpendicular surface or the inclined surface of the outer wall 12 is held. Moreover, if the first support column 31 is unturnably fixed to the second support column 32, by means of turning of the gripper housing 40 with respect to the slide rod 37 by the joint 44, the parallel state of the suction surface 43 of the vacuum gripper 34 with the perpendicular surface or the inclined surface of the outer wall 12 is held.

Subsequently, the turning plate 82 of the fall-preventing plate 64 is gripped and the plate 64 is turned upward from the suspended state, and the plate 40 is inclined with the ascending gradient at a predetermined angle (within a range of an ascending inclination angle 180° from the suspended state) and then, the turning of the turning plate 82 is disabled (fixed) by the turning stopper (the turning (inclination) fixing mechanism), and the inclined state with the ascending gradient of the plate 40 is maintained.

After the fall-preventing plate 64 is inclined with the ascending gradient at a predetermined angle, the slide plate 83 is slid to the front in the front-rear direction from the gondola 10B toward the outer wall 12 of the building 11 by the slide rail 84 so as to extend the plate 64 to the front in the front-rear direction. The slide plate 83 is slid to the front in the front-rear direction until the contact member 85 mounted on the front end portion of the slide plate 83 is brought into contact with the outer wall 12, and after the contact member 85 is brought into contact with the outer wall 12, the slide plate 83 is fixed to the turning plate 82 by the slide stopper (the slide fixing mechanism). The contact member 85 mounted on the front end portion of the slide plate 83 is brought into surface contact with the outer wall 12, and the space 13 between the front frame 48 of the gondola 10B and the outer wall 12 is closed by the fall-preventing plate 64. In the fall-preventing plate 64, since the contact member 85 is in surface contact with the outer wall 12, a gap is not generated between the plate 64 and the outer wall 12.

The handle 75 of the first movable rail 74a is gripped and the first movable rail 74a is slid to the front in the front-rear direction, whereby the second movable rail 74b pressed by the coil spring 76 is slid to the front, the extension/contraction portion 68 of the bellows sheet 66 is extended to the front in the front-rear direction, and the contact member 72 is brought into contact with the outer wall 12 of the building 11 and then, the first movable rail 74a is fixed to the fixed rail 73 by the slide stopper (the slide fixing mechanism). Moreover, those extension/contraction rods 86 are extended to the front in the front-rear direction, their distal-end portions 88 are brought into contact with the front end portion 70 of the extension/contraction portion 68 in the bellows sheet 66 (the outer wall 12 of the building 11), and the contact state of the front end portion 70 of the extension/contraction portion 68 in the bellows sheet 66 with the outer wall 12 is maintained by the extension/contraction rods 86.

Since the second movable rail 74b is urged (pressed) to the front in the front-rear direction by the coil spring 76, whereby the front end portion 70 of the extension/contraction portion 68 in the bellows sheet 66 can be brought into close contact with the outer wall 12 of the building 11, a gap is not generated between the front end portion 70 of the extension/contraction portion 68 in the bellows sheet 66 and the outer wall 12. The contact member 72 mounted on the front end portion 70 of the extension/contraction portion 68 in the bellows sheet 66 is brought into surface contact with the outer wall 12 of the building 11, the space 13 between the front frame 48 of the gondola 10B and the outer wall 12 is surrounded by the extension/contraction portion 68 of the bellows sheet 66, and the space 13 is closed by the extension/contraction portion 68 of the bellows sheet 66. Moreover, since the contact state of the front end portion 70 of the extension/contraction portion 68 in the bellows sheet 66 with the outer wall 12 of the building 11 can be maintained by the extension/contraction rod 86, a gap is not generated between the front end portion 70 of the extension/contraction portion 68 in the bellows sheet 66 and the outer wall 12.

The gondola 10B and the outer wall 12 of the building 11 are coupled/fixed by the vacuum gripper 34, the front end portion (the contact member 85) of the fall-preventing plate 64 is brought into contact with the outer wall 12, and the front end portion 70 (the contact member 72) of the extension/contraction portion 68 in the bellows sheet 66 is brought into contact with the outer wall 12, and in a state where the distal-end portion 88 of the extension/contraction rod 86 is brought into contact with the front end portion 70 (the outer wall 12 of the building 11) of the extension/contraction portion 68 in the bellows sheet 66, the worker reaches his/her hand to the space 13 between the outer wall 12 and the gondola 10B from the front portion 16 (the front-surface opening 58) of the gondola 10B, and the worker performs the various construction works to the outer wall 12 by using various electric tools, manual tools and the like.

In the work gondola 10B, since the gondola 10B is coupled/fixed to the outer wall 12 by the vacuum gripper 34 attached to the outer wall 12 (the outer surface) of the building 11 (the structure), the gondola 10B does not swing or move (does not swing) due to the influence of winds or works but the gondola 10B is made stationary in the air, and the attitude of the gondola 10B in the air is made stable. When an outer-wall repair work for repairing the damaged outer wall 12 is to be performed, the damaged outer wall 12 is chipped (peeled off), but if the outer wall 12 is chipped, a large quantity of solid wastes such as concrete debris, mortar debris, tile debris and the like are generated. If those solid wastes generated during the construction work are scattered to all directions from the gondola 10B or if the solid wastes fall from the gondola 10B, safety in the construction work cannot be ensured.

However, in this gondola 10B, the solid wastes fall on the fall-preventing plate 64, and the wastes follow the fall-preventing plate 64 inclined with the ascending gradient and fall into the gondola 10B (the floor material 22) and thus, the wastes are accommodated in the gondola 10B. Moreover, even if the wastes are scattered or fall toward the space 13 from the fall-preventing plate 64, since the space 13 inside the front frame 48 is surrounded by the bellows sheet 66 and the space 13 is closed by the bellows sheet 66, the wastes scattered or having fallen from the fall-preventing plate 64 are caught by the bellows sheet 66 (the bellows sheet 66 mounted on the lower front rod 51).

After the construction work on the construction work site on the outer wall 12 of the building 11 is completed, the suction stop button of the pendant switch 30 is pressed (suction OFF). When the suction stop button is pressed, the vacuum pump 35 is stopped (the supply of the compressed air to the compressed air generating device is stopped in the built-in type), and the attachment of the suction surface 43 (the sealing foam 41 or the vacuum pad 42) of the vacuum gripper 34 to the outer wall 12 is released. Fixing of the slide rod 37 to the turning rod 36 is released, and the slide rod 37 is slid to the rear in the front-rear direction of the turning rod 36 so as to contract the first support column 31 and then, the slide rod 37 is fixed to the turning rod 36 by the slide stopper (the slide fixing mechanism). The extension/contraction rod 86 is contracted to the rear in the front-rear direction, and its distal-end portion 88 is separated from the front end portion 70 (the outer wall 12 of the building 11) of the extension/contraction portion 68 in the bellows sheet 66 away to the rear.

Subsequently, fixing of the first movable rail 74a to the fixed rail 73 is released by releasing the slide stopper, the handle 79 of the second movable rail 74b is gripped and the first and second movable rails 74a and 74b are slid to the rear in the front-rear direction, and the extension/contraction portion 68 of the bellows sheet 66 is contracted to the rear in the front-rear direction. When the extension/contraction portion 68 of the bellows sheet 66 is contracted to the rear in the front-rear direction, the bellows sheet 66 mounted on the lower front rod 51 is suspended toward the ground, the bellows sheet 66 on that portion forms a waste accommodating bag, and the solid wastes are accommodated in the waste accommodating bag formed by the bellows sheet 66. It is to be noted that, after the construction work is completed, the wastes caught by the bellows sheet 66 may be recovered in the floor material 22 of the gondola 10B before the extension/contraction portion 68 of the bellows sheet 66 is contracted to the rear in the front-rear direction.

After the extension/contraction portion 68 of the bellows sheet 66 is contracted to the rear in the front-rear direction, the first and second movable rails 74a and 74b are fixed to the fixed rail 73 by the slide stopper, and the state where the extension/contraction portion 68 of the bellows sheet 66 is contracted is maintained. Subsequently, the slide stopper is released, fixing of the slide plate 83 to the turning plate 82 is released, the slide plate 83 is slid to the rear in the front-rear direction, and the fall-preventing plate 64 is contracted to the rear in the front-rear direction. After the fall-preventing plate 64 is contracted to the rear in the front-rear direction, the slide plate 83 is fixed to the turning plate 82 by the slide stopper so as to maintain the state where the fall-preventing plate 64 is contracted. Subsequently, the turning stopper (the turning (inclination) fixing mechanism) is released, and the fall-preventing plate 64 is turned downward from the ascending gradient into the suspended state. The lowering button of the pendant switch 30 is pressed so as to lower the gondola 10B to the ground and then, the solid wastes accommodated in the waste accommodating bag formed by the bellows sheet 66 and the solid wastes accommodated in the gondola 10B (the floor material 22) are discarded. After the wastes are discarded, the rise button of the pendant switch 30 is pressed so as to raise the gondola 10B to the subsequent construction work spot, and the work is performed at the construction work spot.

The work gondola 10B has the following effects in addition to the effects of the work gondola 10A in FIG. 1. In the work gondola 10B, the bellows sheet 66 extending in the front-rear direction from the top and bottom portions 18 and 19 (the upper and lower front rods 50 and 51 of the front frame 48) and the both side portions 21 (the both-side front rods 52 of the front frame 48) surrounds the top and bottom portions 18 and 19 and the both side portions 21 of the gondola 10B, and the space 13 between the top and bottom portions 18 and 19 and the both side portions 21 of the gondola 10B and the outer wall 12 of the building 11 can be closed by the extension/contraction portion 68 bellow-folded and extended/contracted in the front-rear direction of the bellows sheet 66 and thus, by catching the solid wastes such as concrete debris, mortar debris, tile debris and the like generated during the construction work to the outer wall 12 by the bellows sheet 66, the wastes can be retained in the gondola 10B, and scattering of the wastes from the gondola 10B to all directions and a fall of the wastes from the gondola 10B can be prevented by the bellows sheet 66.

In the work gondola 10B, by contracting the extension/contraction portion 68 of the bellows sheet 66 to the rear in the front-rear direction, the bellows sheet 66 mounted on the lower front rod 51 is suspended toward the ground, the bellows sheet 66 on that portion forms the waste accommodating bag and thus, the solid wastes caught by the bellows sheet 66 can be accommodated in the waste accommodating bag formed by the bellows sheet 66, and time and labor for recovering the wastes from the bellows sheet 66 to the floor material 22 can be saved.

In the work gondola 10B, the space 13 between the front handrail 24 and the outer wall 12 of the building 11 can be closed by the fall-preventing plate 64 (the turning plate 82 and the slide plate 83), the solid wastes generated during the construction work to the outer wall 12 can be accommodated in the gondola 10B from the fall-preventing plate 64, and scattering of the wastes from the gondola 10B to all directions and a fall of the wastes from the gondola 10B can be prevented by the plate 64.

In the work gondola 10B, since scattering of the solid wastes generated during the construction work to the outer wall 12 of the building 11 from the gondola 10B to all directions and a fall of the wastes from the gondola 10B can be prevented by the fall-preventing plate 64 or the bellows sheet 66, safety around the building during the construction work can be ensured, and there is no need to provide various safety measures such as installation of a protective net or a partition plate and the like or deployment of a watchman around the building, whereby a cost or a labor required for the safety measures can be saved, and the various construction works to the outer wall 12 of the building 11 can be performed rapidly and inexpensively.

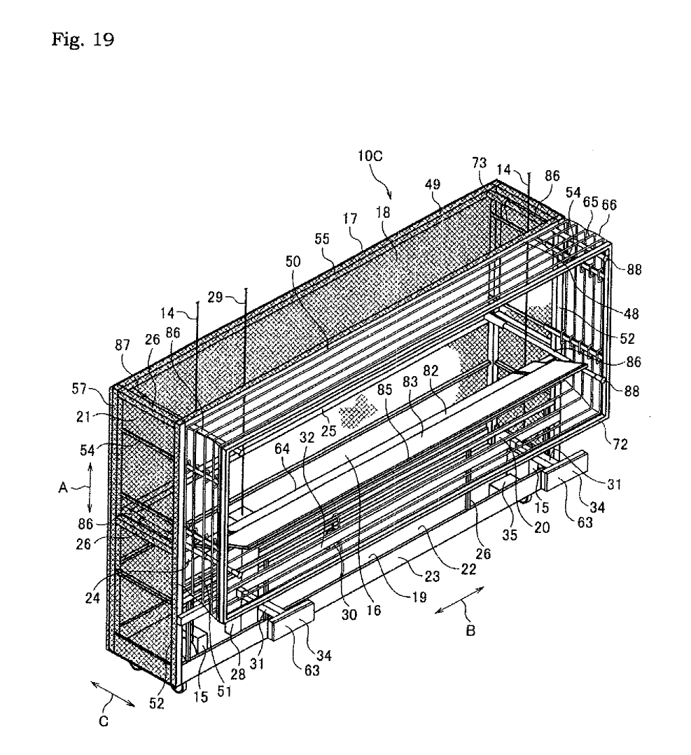

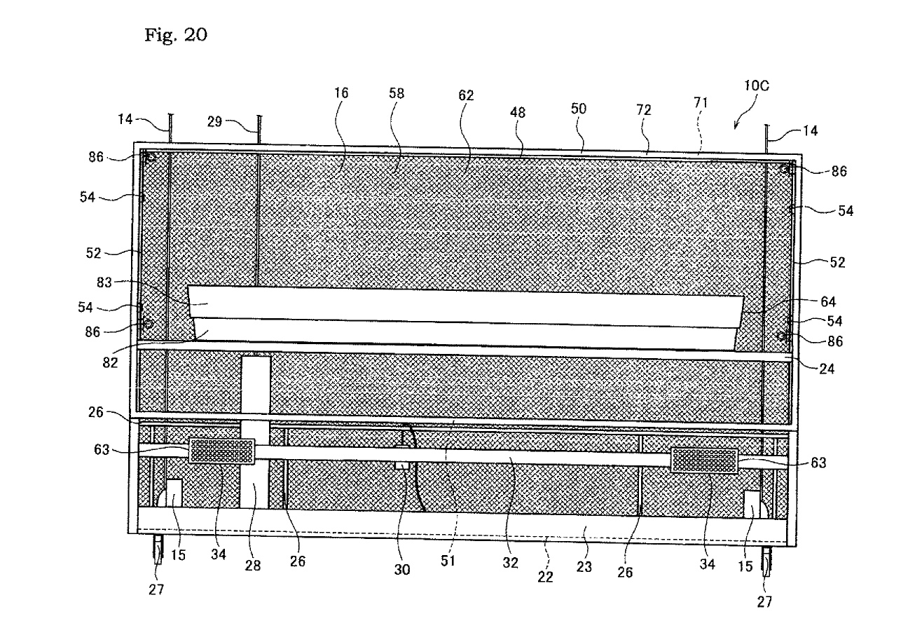

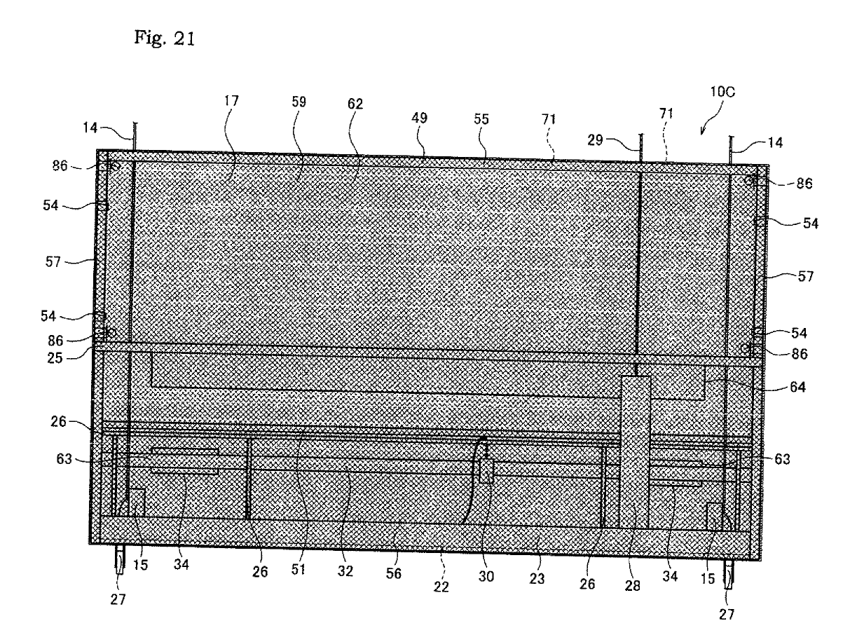

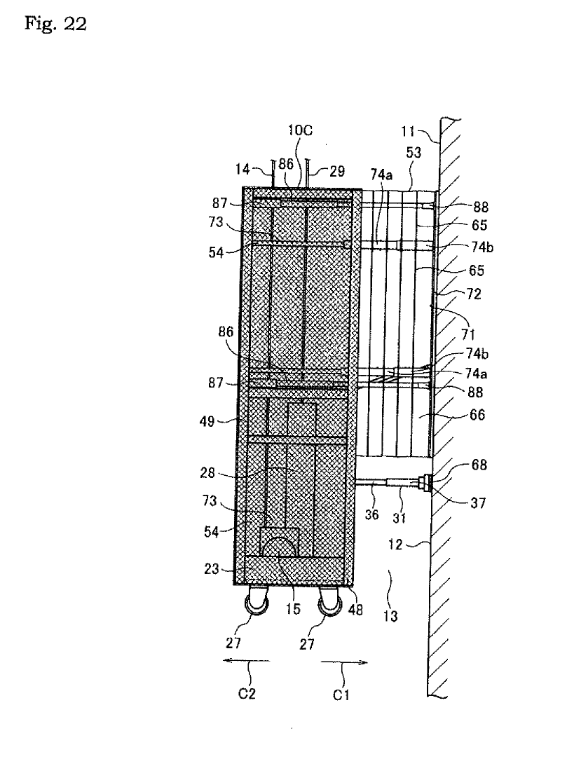

FIG. 19 is a perspective view of a work gondola 10C illustrated as another example, and FIG. 20 is a front view of the work gondola 10C. FIG. 21 is a rear view of the work gondola 10C, and FIG. 22 is a side view of the work gondola 10C after being coupled to the outer wall 12 of the building 11. In FIG. 19, illustration of the net cover 62 is partially omitted. In FIGS. 19 to 22, illustration of the vacuum hose 89 is omitted. FIG. 20 illustrates the fall-preventing plate 64 in the extended state, and FIG. 21 illustrates the fall-preventing plate 64 in the suspended state. In FIG. 19, the vertical direction is indicated by the arrow A, the width direction by the arrow B, and the front-rear direction by the arrow C. In FIG. 22, the front in the front-rear direction is indicated by the arrow C1, and the rear in the front-rear direction by the arrow C2.

This work gondola 10C is different from that in FIG. 10 in a point that the front frame 48 is installed from immediately below the fall-preventing plate 64 (immediately below the front handrail 24) to above, and the cover sheet 53 is attached to the front frame 48, and since the other constitutions of this gondola 10C is the same as those of the gondola 10B, the same reference numerals as those in FIG. 10 are given, and by employing the description of the gondola 10B in FIG. 10 by analogy, detailed description of the other constitutions of the gondola 10C is omitted.

The work gondola 10C is, similarly to those in FIG. 1 and FIG. 10, used in order to ensure a safe scaffold in a high-place work when various construction works are performed to the building 12 (the structure). The gondola 10C is disposed on the outer side of the outer wall 12 of the building 11 and is suspended from the rooftop of the building 11 by the elevating device (the hoisting accessory, the hoisting wire rope 14, the hoisting machine 15), capable of elevating in the vertical direction. The gondola 10C has the front portion 16, the rear portion 17, the top portion 18, the bottom portion 19, the center portion 20, and the both side portions 21.

The work gondola 10C is made by the floor material 22 installed on the bottom portion 19 and having a predetermined area, the bottom frame 23 (the floor material support plate) supporting the floor material 22, the front frame 48 (the front frame) installed on the front portion 16, the rear frame 49 (the rear frame) installed on the rear portion 17, the front handrail 24 (the front handrail) and the rear handrail 25 (the rear handrail) located above the floor material 22 and extending in the width direction, and a plurality of the reinforcing columns 26 coupled to the frames 48 and 49, the front handrail 24, and the rear handrail 25.

The floor material 22, the bottom frame 23, the rear frame 49, the front handrail 24, the rear handrail 25, and the reinforcing column 26 are the same as those in the gondola 10B in FIG. 10. The bottom frame 23, the front frame 48, the rear frame 49, the front handrail 24, the rear handrail 25, and the reinforcing column 26 are coupled by welding. In the gondola 10C, a work space surrounded by the floor material 22, the floor frame 23, the front frame 48, the rear frame 49, the front handrail 24, the rear handrail 25, and the reinforcing column 26 is defined.

The front frame 48 is formed by the upper front rod 50 (upper rod) located on the top portion 18 of the gondola 10C and extending in the width direction, the lower front rod 51 (lower rod) located on the center portion 20 of the gondola 10C and immediately below the front handrail 24 (immediately below the fall-preventing plate 64) and extending in the width direction, and both-side front rods 52 (both side rods) located on the both side portions 21 of the gondola 10C and extending in the vertical direction between the upper and lower front rods 50 and 51. The front frame 48 surrounds the front-surface opening 58 located from immediately below the front handrail 24 (the center portion 20 of the gondola 10C) to above.

On the upper part and the center portion of the both-side front rods 52, the slide rail 54 extending in the front-rear direction is installed. It is to be noted that the slide rail 54 may be installed on both side portions of the upper and lower front rods 50 and 51. On the front handrail 24, the fall-preventing plate 64 on which the contact member 85 is mounted and extending in the width direction is installed. On the first corner part where the upper front rod 50 crosses the both-side front rods 52 and the center portion in the vertical direction of the both-side front rods 52, the extension/contraction rod 88 is detachably installed, and the extension/contraction rod 88 extends in the front-rear direction from the first corner part and the center portion. The slide rail 54, the fall-preventing plate 64, and the extension/contraction rod 88 are the same as those in the gondola 10B in FIG. 10.

On the front frame 48 (the upper and lower front rods 50 and 51 and the both-side front rods 52), the cover sheet 3 is attached. The cover sheet 53 is, similarly to that in the gondola 10B in FIG. 10, formed by the plurality of bellows frames 65 located on the space 13 and arrayed in the front-rear direction and the bellows sheet 66 mounted on the bellows frames 65 and extending in the front-rear direction. The bellows sheet 66 surrounds from immediately below the front handrail 24 (the center portion 20 in the gondola 10B) to the top portion 18 in the front-surface opening 58 of the gondola 10B and extends in the front-rear direction from the front frame 48.

The bellows sheet 66 has the fixed portion 67 fixed to the upper and lower front rods 50 and 52 and the both-side front rods 52 (front frames 22) and the extension/contraction portion 68 extending to the front in the front-rear direction from the fixed portion 67. The extension/contraction portion 68 is folded into a bellows in the front-rear direction between those bellows frames 65. On the front end portion 70 (the front end portion) of the extension/contraction portion 68 in the bellows sheet 66, the contact frame 71 made of metal or made of a synthetic resin and the contact member 72 having cushioning characteristics (flexibility) and a predetermined area and a predetermined thickness are mounted.

On the entire region of the rear-surface opening 59, the entire region of the top-surface opening 60, and the entire regions of the both-side openings 61, the net cover 62 is installed, and those openings 59 to 61 are covered by the net cover 62. The net cover 62 is the same as that in the gondola 10B in FIG. 10. On the front portion 16 of the gondola 10C, the suction attachment device 63 for coupling (fixing) the gondola 10C to the outer wall 12 (making the gondola 10C stationary in the air) while being attached to the outer wall 12 of the building 11 is installed. The suction attachment device 63 is the same as those installed in the gondolas 10A and 10B in FIGS. 1 and 10.

Below each corner part of the bottom frame 23, the caster 27 is mounted. On the floor material 22 on the both side portions 21 of the gondola 10C, the hoisting machine 15 to which the hoisting wire rope 14 is connected is installed/fixed, and on the floor material 22 on one of the side portions 21 of the gondola 10C, the control panel 28 for gondola is placed/fixed. To the control panel 28 for gondola, the power cable 29 suspended from the roof top of the building 11 is connected, and electricity is supplied to each of the hoisting machines 15 from the control panel 28 by the power cable (not shown). On the reinforcing column 26, the pendant switch 30 connected to the control panel 28 for gondola through the cable is hooked. Since a procedure for performing the various construction works to the outer wall 12 of the building 11 by using the work gondola 10C is the same as the procedure for performing the various construction works to the outer wall 12 of the building 11 by using the gondola 10B, the description will be omitted.

The work gondola 10C has, similarly to that in FIG. 10, the following effects in addition to the effects of the work gondola 10A in FIG. 1. In the work gondola 10C, the bellows sheet 66 surrounds the top portion 18, the center portion 20, and the both side portions 21 of the gondola 10C, and the space 13 can be closed by the extension/contraction portion 68 bellow-folded and extended/contracted in the front-rear direction of the bellows sheet 66 and thus, by catching the solid wastes such as concrete debris, mortar debris, tile debris and the like generated during the construction work to the outer wall 12 by the bellows sheet 66, the wastes can be retained in the gondola 10C, and scattering of the wastes from the gondola 10C to all directions and a fall of the wastes from the gondola 10C can be prevented by the bellows sheet 66. It is to be noted that, by contracting the extension/contraction portion 68 in the bellows sheet 66 to the rear in the front-rear direction, the bellows sheet 66 mounted on the lower front rod 51 is suspended toward the ground, and the bellows sheet 66 of that portion forms a waste accommodating bag, and the solid wastes caught by the bellows sheet 66 can be accommodated in the waste accommodating bag formed by the bellows sheet 66 and thus, time and labor for recovering the wastes from the bellows sheet 66 to the floor material 22 can be saved.

In the work gondola 10C, the space 13 between the front handrail 24 and the outer wall 24 of the building 11 can be closed by the fall-preventing plate 64 and thus, the solid wastes generated during the construction work to the outer wall 12 can be accommodated in the gondola 10C from the fall-preventing plate 64, and scattering of the wastes from the gondola 10C to all directions and a fall of the wastes from the gondola 10C can be prevented by the plate 64. In the gondola 10C, since scattering of the solid wastes generated during the construction work to the outer wall 12 of the building 11 from the gondola 10C to all directions and a fall of the wastes from the gondola 10B can be prevented by the bellows sheet 66 or the fall-preventing plate 64, safety around the building during the construction work can be ensured, and there is no need to provide various safety measures such as installation of a protective net or a partition plate and the like or deployment of a watchman around the building, whereby a cost or a labor required for the safety measures can be saved, and the various construction works to the outer wall 12 of the building 11 can be performed rapidly and inexpensively.

In those gondolas 10A to 10C, it may be so configured that the bellows sheet 66 is not installed on the top portion 18 of the gondolas 10A to 10C but installed only on the bottom portion 19 or the center portion 20 and the both side portions 21 of the gondolas 10A to 10C. In this case, the front frame 48 is formed by the lower front rod 51 (lower rod) located on the bottom portion 19 or the center portion 20 of the gondolas 10A to 10C and extending in the width direction and the both-side front rods 52 (both side rods) located on the both side portions 21 of the gondolas 10A to 10C and extending in the vertical direction.

### REFERENCE SIGNS LIST

10A work gondola
10B work gondola
10C work gondola
11 building (structure)
12 outer wall (outer surface)
13 space
14 hoisting wire rope
15 hoisting machine
16 front portion
17 rear portion
18 top portion
19 bottom portion
20 center portion
21 both side portion
22 floor material
23 bottom frame
24 front handrail
25 rear handrail
26 reinforcing column
27 caster
28 control panel for gondola
29 power cable
30 pendant switch
31 first support column
32 second support column
33 distal-end portion
34 vacuum gripper
35 vacuum pump
36 turning rod
37 slide rod
38 base-end portion
39 joint
40 gripper housing
41 sealing foam
42 vacuum pad
43 suction surface
44 joint
45 suction hole
46 suction port
47 net cover
48 front frame
49 rear frame
50 upper front rod (upper rod)
51 lower front rod (lower rod)
52 both-side front rod (both side rod)
53 cover sheet
54 slide rail
55 upper rear rod
56 lower rear rod
57 both-side rear rod
58 front-surface opening
59 rear-surface opening
60 top-surface opening
61 both-side opening
62 net cover
63 suction attachment device
64 fall-preventing plate
65 bellows frame
66 bellows sheet
67 fixed portion
68 extension/contraction portion
69 runner ring
70 front-end portion
71 contact frame
72 contact member
73 fixed rail
74 movable rail
74a first movable rail
74b second movable rail
75 handle
76 coil spring
77 rear end portion
78 spring receiving plate
79 handle
80 front end portion
81 spring contact plate
82 turning plate
83 slide plate
84 slide rail
85 contact member
86 extension/contraction rod
87 base-end portion
88 distal-end portion
89 vacuum hose

1. A work gondola disposed on an outer side of a structure, capable of elevating in a vertical direction by using an elevating device, and used in various construction works to the structure, characterized in that
the work gondola has a suction attachment device installed on a front portion of the gondola faced with the structure and coupling the gondola to the structure while being attached to the outer surface of the structure by suction.

2. The work gondola according to claim 1, wherein
the suction attachment device is formed by a first support column extending in a front-rear direction from the front portion of the gondola and a vacuum gripper mounted on a distal-end portion of the first support column, and the vacuum gripper is formed by a gripper housing having a suction surface with a predetermined area and a sealing foam or a plurality of elastically deformable vacuum pads installed on the suction surface of the gripper housing, having a plurality of suction ports and having a predetermined area and a predetermined thickness with flexibility.

3. The work gondola according to claim 2, wherein
the vacuum gripper is coupled to the distal-end portion of the first support column turnably by a joint.

4. The work gondola according to claim 2, wherein
the suction attachment device includes a second support column installed on the front portion of the work gondola and extending in a width direction, and the first support column is coupled to the second support column turnably and slidably in the width direction by the joint.

5. The work gondola according to claim 2, wherein
the first support column is formed by a turning rod coupled to the second support column turnably and slidably in the width direction by the joint and at least one slide rod slidable in the front-rear direction from the turning rod.

6. The work gondola according to claim 1, wherein
the work gondola includes a cover sheet capable of being extended/contracted and installed at least on a bottom portion or a center portion and both side portions in a top portion and the bottom portion or the center portion and the both side portions thereof, extending in a front-rear direction from the front portion and closing a space between the gondola and the structure, and the cover sheet is capable of adjusting a length dimension in the front-rear direction in accordance with a distance of the space.

7. The work gondola according to claim 6, wherein
the work gondola includes a front frame installed on the front portion, the front frame is formed at least by a lower rod and both side rods in an upper rod located at a top portion of the gondola and extending in the width direction, the lower rod located on the bottom portion or the center portion of the gondola and extending in the width direction, and the both side rods located on the both side portions of the gondola and extending in the vertical direction, and the cover sheet is installed at least on the lower rod and the both side rods in the upper and lower rods and the both side rods.

8. The work gondola according to claim 6, wherein
a contact member having cushioning characteristics and in contact with the outer surface of the structure and having a predetermined area and a predetermined thickness is mounted on a front end portion of the cover sheet faced with the structure.

9. The work gondola according to claim 7, wherein
the work gondola includes a slide rail extending in the front-rear direction from at least upper and lower parts of the both side rods in the both side portions of the upper and lower rods and the upper and lower parts of the both side rods and extending/contracting the cover sheet in the front-rear direction, the slide rail is formed by a fixed rail fixed to the rod and at least one movable rail installed on the cover sheet and slidable in the front-rear direction from the fixed rail, and a coil spring urging the movable rail to a front in the front-rear direction is installed on the slide rail.

10. The work gondola according to claim 7, wherein
the work gondola includes an extension/contraction rod capable of extending/contracting in the front-rear direction and maintaining a contact state of the front end portion of the cover sheet with the structure, and the extension/contraction rod has a base-end portion installed on the gondola and a distal-end portion for pressing the front end portion of the cover sheet and extends in the front-rear direction from at least one of a first corner part where the upper rod crosses the both side rods, a second corner part where the lower rod crosses the both side rods, and center portions in the vertical direction of the both side rods.

11. The work gondola according to claim 7, wherein
the cover sheet is formed by a plurality of bellows frames located on the space and arrayed in the front-rear direction and a bellows sheet mounted on the bellows frames and capable of extension/contraction in the front-rear direction, the bellows sheet has a fixed portion fixed to the front frame and an extension/contraction portion extending to the front in the front-rear direction from the fixed portion and bellow-folded in the front-rear direction between those bellows frames, and the contact member is mounted on the front end portion of the extension/contraction portion of the bellows sheet faced with the structure.

12. The work gondola according to claim 7, wherein
the work gondola includes a front handrail extending in the width direction between the both side rods and a fall-preventing plate installed on the front handrail and closing the space, the fall-preventing plate is formed by a turning plate turnably installed on the front handrail and at least one slide plate slidable in the front-rear direction from the turning plate, and when the fall-preventing plate is in use, the turning plate and the slide plate are inclined with an ascending gradient from the front handrail toward the structure.

13. The work gondola according to claim 12, wherein
the contact member having the cushioning characteristics and in contact with the outer surface of the structure and having the predetermined area is mounted on the front end portion of the fall-preventing plate faced with the structure.

14. The work gondola according to claim 1, wherein
the work gondola includes a net cover covering a top-surface opening opened on the top portion thereof, both side surface openings opened on the both side portions thereof, and a rear-surface opening opened on a rear portion of the gondola not faced with the structure.
